(19) United States
(12) Patent Application Publication
(10) Pub. No.: US 2012/0008510 A1
(43) Pub. Date: Jan. 12, 2012

(54) Method and Apparatus for Performing Uplink Antenna Transmit Diversity

(75) Inventors: Lujing Cai, Morganville, NJ (US); Benoit Pelletier, Roxboro (CA); Fengjun Xi, Huntington Station, NY (US); Joseph S. Levy, Merrick, NY (US); Andrew Irish, Montreal (CA)

(73) Assignee: INTERDIGITAL PATENT HOLDINGS, INC., Wilmington, DE (US)

(21) Appl. No.: 12/986,339

(22) Filed: Jan. 7, 2011

Related U.S. Application Data
(60) Provisional application No. 61/293,085, filed on Jan. 7, 2010.
(60) Provisional application No. 61/389,003, filed on Oct. 1, 2010.

(51) Int. Cl. H04W 24/00

(52) U.S. Cl. 370/252

(57) ABSTRACT

Systems, methods, and instrumentalities are disclosed to provide antenna transmit diversity. A wireless transmit/receiver unit (WTRU) may comprise multiple antennas. A channel condition for each of the antennas may be determined. A probing phase may be used in order to determine the channel conditions. During a period of the probing phase, a probing signal from each antenna may be transmitted during a respective time interval. The WTRU transmit power may or may not be held constant. A Node B may receive each probing signal and determine channel quality information. The Node B may adjust the determined channel quality information if there is a power offset between the signals. The Node B may send the channel quality information to the WTRU. The WTRU may switch an antenna to use for uplink transmission based on the received channel quality information.

### CROSS-REFERENCE TO RELATED APPLICATIONS

This application is based on, and claims priority to, U.S. Provisional Patent Application No. 61/293,085, filed on Jan. 7, 2010, and U.S. Provisional Patent Application No. 61/389,003, filed on Oct. 1, 2010, the contents of which are hereby incorporated by reference in their entirety.

### BACKGROUND

Smart antenna technologies have been widely used in cellular communication systems as an effective means to improve robustness of data transmission and achieve higher data throughput. The switched antenna technology, which has the configuration of multiple transmit antennas, alternately performs data transmission at different antennas and thus achieves spatial diversity in order to combat fading channels. However, uplink transmit (TX) diversity is unavailable, e.g., in a 3GPP WCDMA based cellular communication system.

### SUMMARY

Systems, methods, and instrumentalities are disclosed to provide antenna transmit diversity. For example, a wireless transmit/receiver unit (WTRU) may include multiple antennas. A channel condition for each of the antennas may be determined in order to select an antenna to use for uplink transmission. A probing phase may be used in order to determine the channel conditions. During a period of the probing phase, the WTRU transmit power may be held constant. During the period, a probing signal from each antenna may be transmitted during a respective time interval. The WTRU may receive channel quality information related to the transmitted probing signals (e.g., from a Node-B). The WTRU may switch (e.g., choose) an antenna to use for uplink transmission based on the received channel quality information. For example, the channel quality information may provide an indicator that directs the WTRU to use a specific antenna, or, the channel quality information may include information that may be evaluated by the WTRU, where the WTRU chooses an antenna based on the evaluation.

A channel condition for each of the antennas may be determined without holding the transmit power constant. For example, a Node-B may receive a probing signal from each of the antennas during a period of the probing phase. Each probing signal may have been transmitted at a respective measurement time. Transmit power may be different for each probing signal, e.g., due to power control adjustments implemented in the uplink. The Node-B may determine a power change offset between measurement times. The Node-B may calculate channel quality information related to the received probing signals. In calculating the channel quality information, the Node-B may use the power change offset to compensate for a difference in transmission power between the probing signals. The Node-B may send the channel quality information to the WTRU.

### BRIEF DESCRIPTION OF THE DRAWINGS

A more detailed understanding may be had from the following description, given by way of example in conjunction with the accompanying drawings.

FIG. 1 shows an example wireless communication system including a plurality of WTRUs, a Node-B, a controlling radio network controller (CRNC), a serving radio network controller (SRNC), and a core network.

FIG. 2 is an example functional block diagram of a WTRU and Node-B of the wireless communication system of FIG. 1.

FIG. 3 shows an example SISO based transmitter structure for WCDMA/HSPA.

FIG. 4 shows an example SISO based receiver structure for WCDMA/HSPA.

FIG. 5 shows an example WTRU transmitter structure with antenna switching (AS) diversity.

FIG. 6 shows an example power loop control diagram with AS.

FIG. 7 shows an example DPCCH gain control unit for AS.

FIG. 8 shows an example of a state machine.

FIG. 9 shows an example switch timing diagram of antennas.

FIG. 10 shows an example switch timing diagram of antennas with a guard interval.

FIG. 11 is an example high level block diagram for the closed loop antenna switching system.

FIGS. 12 and 13 show example implementations of the common gain function.

FIG. 14 shows an example implementation of the concept of a virtual power control loop.

FIG. 15 shows an example switching control function at the Node B.

FIG. 16 shows an example functional block diagram of the switching control function at a UE.

FIG. 17 shows example signaling sent to UE from the Node B.

FIG. 18 shows an example Node B controlled and UE assisted AS.

FIG. 19 shows an example UE controlled AS.

FIG. 20 shows an example of constant TX power in entire probing mode.

FIG. 21 shows an example of constant TX power within a switch cycle.

FIG. 22 shows an example of constant TX power within a last switch cycle.

FIG. 23 shows an example timing illustration when measurements are taken.

FIG. 24 shows an example beam forming system with single pilot.

FIG. 25 shows an example of a fixed pattern probing mode.

FIG. 26 shows an example measurement timing with multiple probing states.

FIG. 26A is a system diagram of an example communications system in which one or more disclosed embodiments may be implemented;

FIG. 26B is a system diagram of an example wireless transmit/receive unit (WTRU) that may be used within the communications system illustrated in FIG. 17A;

FIG. 26C is a system diagram of an example radio access network and an example core network that may be used within the communications system illustrated in FIG. 17A;

### DETAILED DESCRIPTION OF ILLUSTRATIVE EMBODIMENTS

When referred to hereafter, the terminology “wireless transmit/receive unit (WTRU)” includes but is not limited to a user equipment (UE), a mobile station, a fixed or mobile subscriber unit, a pager, a cellular telephone, a personal digital assistant (PDA), a computer, or any other type of user device capable of operating in a wireless environment. As used herein, the terms UE and WTRU may be coextensive. When referred to hereafter, the terminology “base station” includes but is not limited to a Node-B, a site controller, an access point (AP), or any other type of interfacing device capable of operating in a wireless environment.

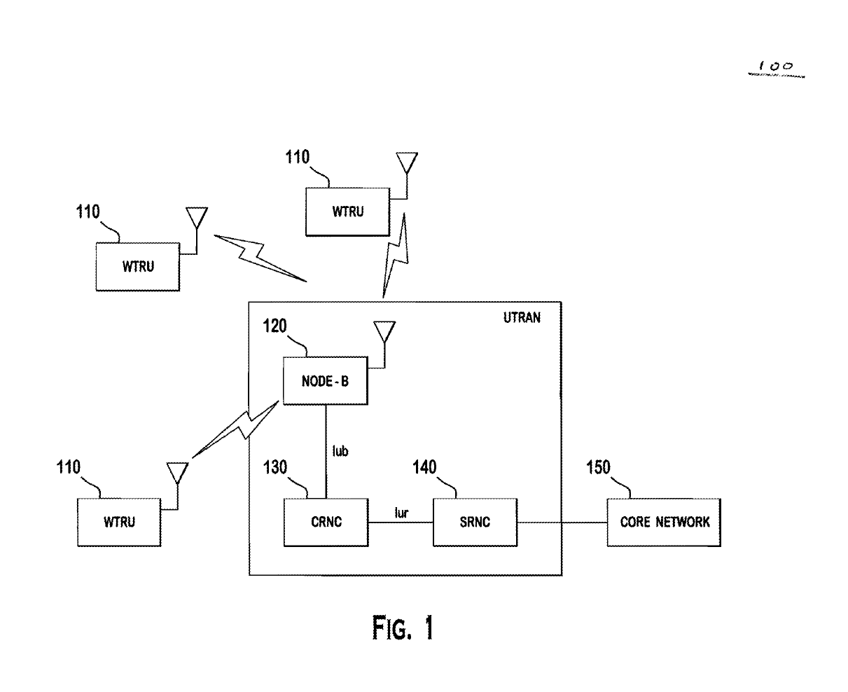

FIG. 1 shows an example wireless communication system 100 including a plurality of WTRUs 110, a Node-B 120, a controlling radio network controller (CRNC) 130, a serving radio network controller (SRNC) 140, and a core network 150. The Node-B 120 and the CRNC 130 may collectively be referred to as the UTRAN.

As shown in FIG. 1, the WTRUs 110 are in communication with the Node-B 120, which is in communication with the CRNC 130 and the SRNC 140. Although three WTRUs 110, one Node-B 120, one CRNC 130, and one SRNC 140 are shown in FIG. 1, it should be noted that any combination of wireless and wired devices may be included in the wireless communication system 100.

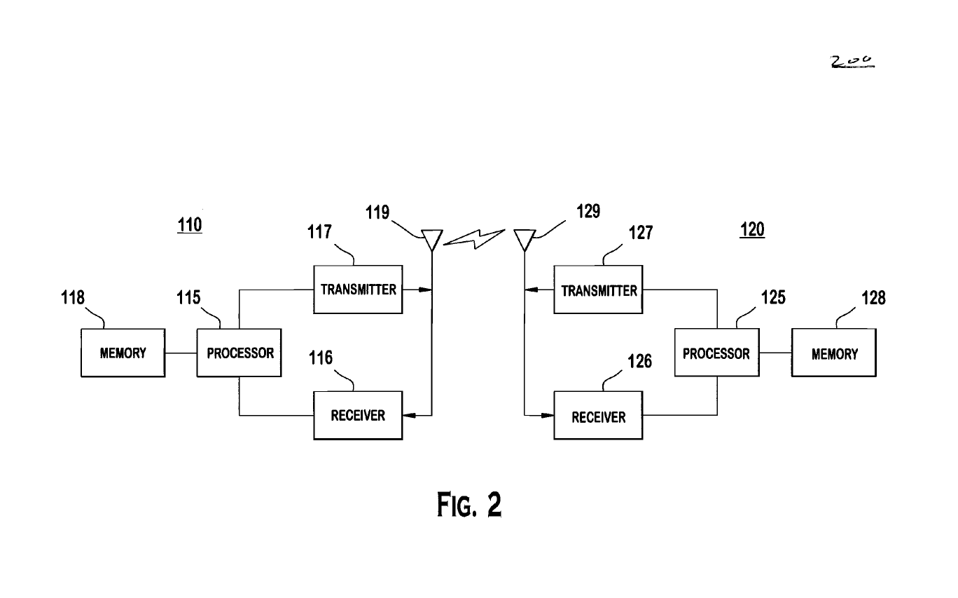

FIG. 2 is an example functional block diagram 200 of a WTRU 110 and the Node-B 120 of the wireless communication system 100 of FIG. 1. As shown in FIG. 2, the WTRU 110 is in communication with the Node-B 120 and both are configured to perform a method of performing TPC-based switched antenna transmit diversity.

In addition to the components that may be found in a typical WTRU, the WTRU 110 may include a processor 115, a receiver 116, a transmitter 117, a memory 118 and an antenna 119. The memory 118 is provided to store software including operating system, application, etc. The processor 115 is provided to perform, alone or in association with the software, a method of performing TPC-based switched antenna transmit diversity. The receiver 116 and the transmitter 117 are in communication with the processor 115. The antenna 119 is in communication with both the receiver 116 and the transmitter 117 to facilitate the transmission and reception of wireless data.

In addition to the components that may be found in a typical Node-B, the Node-B 120 may include a processor 125, a receiver 126, a transmitter 127, a memory 128 and an antenna 129. The processor 125 is configured to perform a method of performing TPC-based switched antenna transmit diversity. The receiver 126 and the transmitter 127 are in communication with the processor 125. The antenna 129 is in communication with both the receiver 126 and the transmitter 127 to facilitate the transmission and reception of wireless data.

Below is described a switched antenna technology that may be used for uplink transmission in a Third Generation Partnership Project (3GPP) universal mobile telecommunications system (UMTS) communication system. This technology realizes an implicit closed-loop transit diversity by reusing information derived from the existing uplink power control loop to direct the selection of the antennas. Various probing techniques are specially designed to address the needs of HSUAP where fast uplink resource scheduling is relaying on highly dynamic TX power control. Furthermore, some of proposed technologies are adapted to beam forming transmit diversity in scenarios when simultaneous estimation of the two antenna paths is not available. For better coordination between a WTRU and the network and minimizing the impact on other procedures, the related control and signaling mechanisms are also presented.

Though examples may be illustrated with reference to a two-antenna configuration, the systems, methods, and instrumentalities disclosed herein may be generalized to multiple antenna systems. Additionally, although various standards and technologies may be described with regard to the description herein, other standards and/or technologies may be applied.

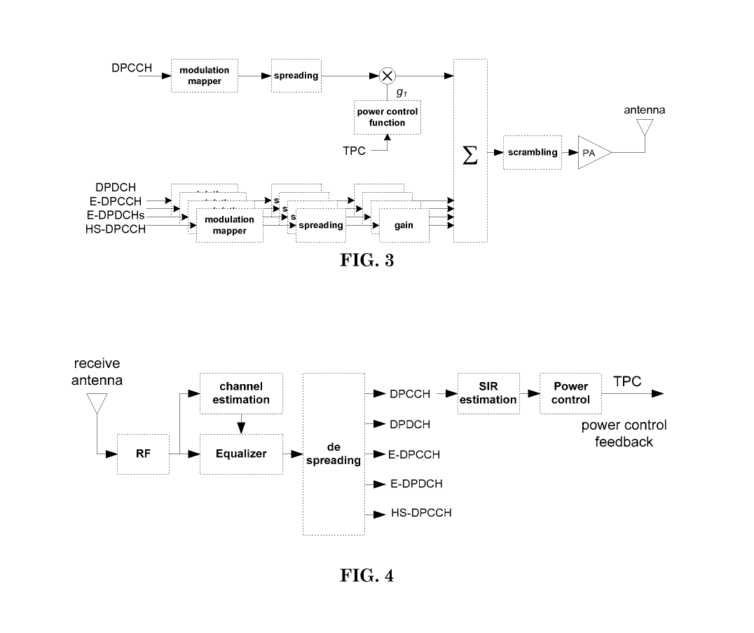

A conventional SISO-based WCDMA/HSPA communication system for uplink transmission is depicted in FIG. 3 and FIG. 4, where a WTRU transmit system and a base station receive system are shown respectively. DPCCH and DPDCH, are physical channels specified in Release 99 that may carry data traffic at low rate mainly for voice. The channels, E-DPCCH, E-DPDCH, and HS-DPCCH are for HSPA operation that may carry high speed data. Each of the physical channels, after encoding processing, may be modulated and spread by different channelization code individually. Different gain factors may be applied to each channel for transmit power management, which may be managed by the network for uplink resource allocation and interference control. The channels may be combined into either in-phase or quadrature components of a complex signal, which may be further processed by a WTRU specific scrambler and then sent to the antenna for transmission.

Since there is one transmit antenna, the combination of the processing blocks as mentioned above are referred to as a TX chain as a whole.

At the base station receiver side, the received signal from the receive antenna may be processed by an equalizer to remove the ISI and mitigate the impact of a multipath effect. The equalizer may be designed as a conventional rake receiver at low complexity, or as an advanced receiver with better performance, such as an LMMSE equalizer. Either way, channel estimation may be required in order to undo the distortion introduced by the propagation channel. To separate each of the physical channels, de-spreading processing may be performed with use of a channelization code corresponding to that channel. These separated signals may be sent for decoding individually to get final binary data, which is not depicted in the system block diagram for simplicity of presentation.

There is a power control mechanism for the uplink transmission in WCDMA/HSPA, for which an inner power control loop is designed across both uplink and downlink directions. In the UL receiver at the base station, the signal to interference ratio (SIR) of the uplink DPCCH is monitored and maintained to a value specified by a higher layer. If it is different from the target value configured, an adjustment may be performed by feeding back a TPC (transmission power control) command to the WTRU via the downlink DPCCH or F-DCH channel. Upon receiving TPC, the gain factor g₁ may be adjusted up or down to control the transmission power of the DPCCH depending on the TPC command. The transmission power of the other channels may be set with reference to the DPCCH to reach their performance target. That is, when the power of the DPCCH is altered the overall WTRU transmission power may vary proportionally.

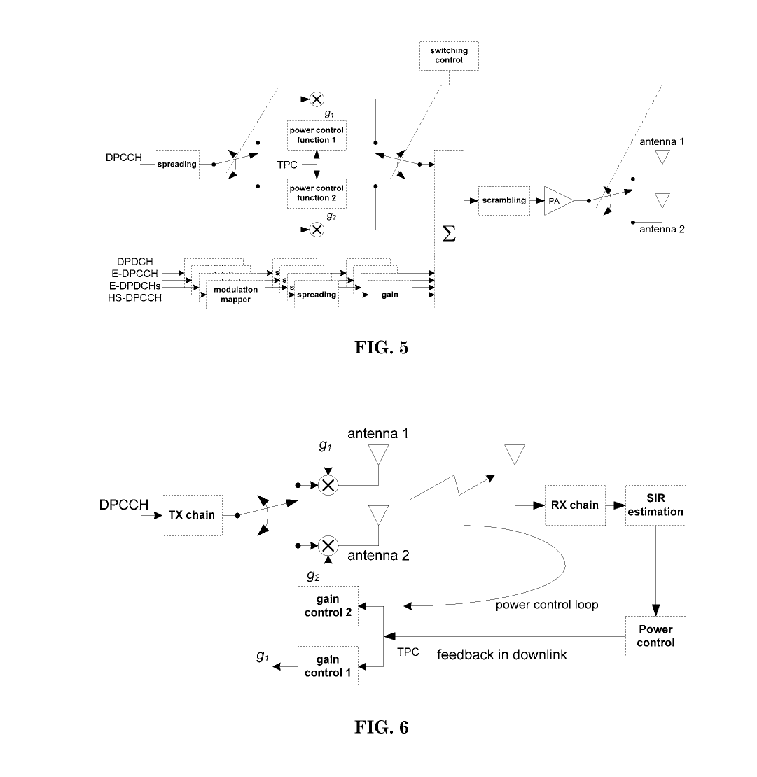

Uplink transmission may be performed with antenna switching TX diversity. Antenna switching may be implemented by introducing one or more transmission antennas, while still maintaining one TX chain at WTRU. An example system block diagram for a transmitter configured for antenna switching is shown in FIG. 5, where the same TX chain is maintained as in the SISO system, e.g., one PA and one set of processing blocks. The number of gain control functions for the DPCCH channel is expanded to two, one for each antenna. With use of the control of the switching control block newly introduced, the switching between the two gain control functions may be performed simultaneously with switching of the two antennas.

Two examples of an AS system are proposed for HSUPA in the following subsections—TPC-based antenna switching and closed loop antenna switching—which may depend on whether the switching control is performed via implicit or explicit feedback from the network.

TPC-based antenna switching design may minimize the impact on the configuration at the base station so that the WTRU with antenna switching (AS) can be brought into the existing deployment. Performance enhancement, e.g., from uplink transmit diversity, may be achieved without the awareness of use of the AS technology on the base station side. For this purpose, the UL receiver at the base station may remain the same as shown in FIG. 4. The power control loop at the Node B side may be unchanged. In particular, the SIR and TPC commands may be set in a manner similar to the situation where no AS is applied at the WTRU side. An example overall power loop configuration for AS is illustrated in FIG. 6.

The AS may operate in two different modes: probing mode and operation mode. In probing mode, the AS may be performed with a pre-defined pattern (e.g., such as equal duty cycle) that is designed to explore the channel conditions of two antennas individually. Though UL data transmission is still conducted in this mode, its performance may not be optimized.

Assuming steady state is reached in the probing mode, e.g., SIR is getting close to stable regardless which antenna WTRU is transmitting with, the gain factor, g1 or g2, obtained from the power control function may comprise the channel quality information for that antenna. In the operation mode, the antenna selection may be conducted adaptively based on the criterion made with the gain factor as input. For example, if g1>g2, antenna 2 may operate most of time and antenna 1 may be possibly given very small duty cycle just for maintaining the power control loop.

From a performance perspective, this way of switching may help to reduce WTRU transmit power which in turn may lead to a reduced interference level and improved system capacity. In a wider sense, it may implement an implicit closed loop TX diversity because the channel condition information is indirectly fed back to WTRU via the power control loop mechanism.

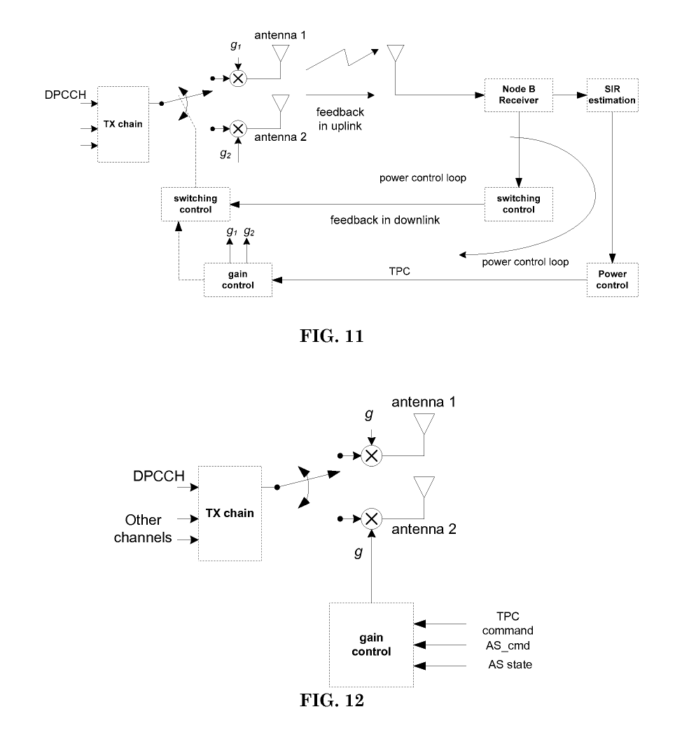

When direct feedback from the Node B receiver is available, the antenna switching action at the UE may be under close control of the network via the switching control functions at both UE and/or Node B, which are connected by downlink signaling that carries the explicit feedback from the Node B receiver. A feedback signaling link may be established in the uplink to enhance the uplink transmission reliability. It may be used to carry the status information pertaining to antenna switching at the UE. An example high level block diagram for a closed loop antenna switching system is shown in FIG. 11.

The concept of the probing/operation modes may apply to closed loop AS. A difference may be that the switching control function at Node B, which may have better and the most updated information about the uplink signal quality and channel conditions, may be fully engaged in controlling the use of the modes.

The gain control function for closed loop antenna switching may serve a similar purpose as described above in stabilizing the power control loop, except that the output of the gain control function may be or may not be used in assisting the antenna switching decision.

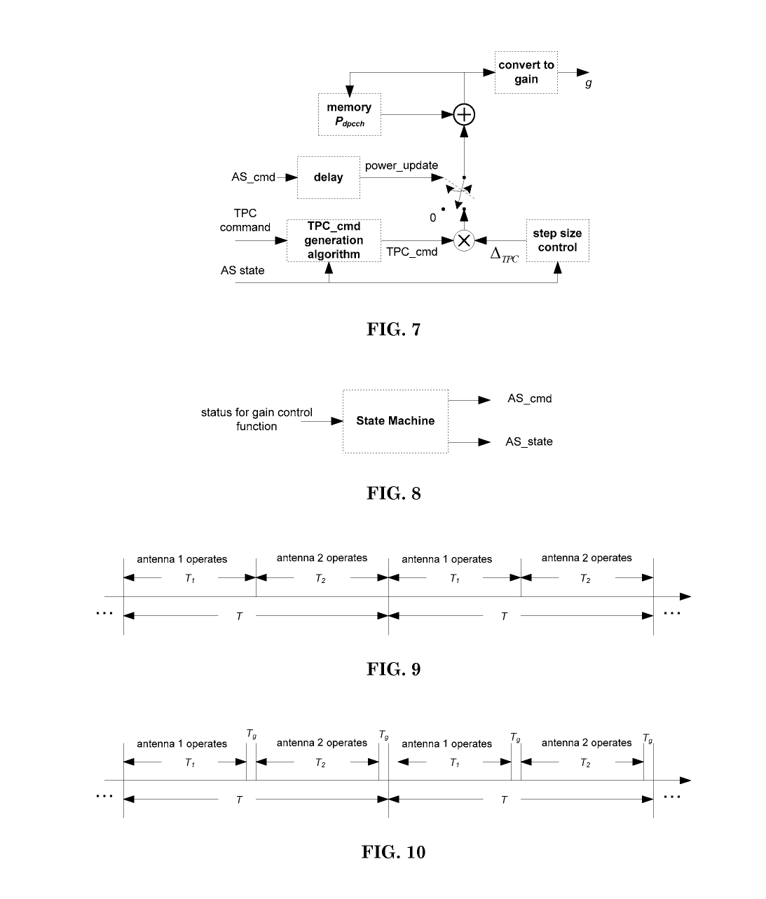

The gain control function may execute the TPC command and translate it to the gain factor that is multiplied to the DPCCH signal to control the ultimate transmission power measured at the connector of transmit antenna. With use of antenna switching, gain control unit is shown in FIG. 7.

Upon reception from the downlink feedback channel, the TPC command may be decoded as a binary value either equal to 0 or 1. This binary value may in turn be converted to TPC_cmd based on one of the following example algorithms:

Algorithm 1:
If TPC command=0, TPC_cmd=−1;
If TPC command=1, TPC_cmd=1.

Algorithm 2:
For the first four slots of a set of five slots, TPC_cmd=0.
For the fifth slot of a set:

If all five hard decisions within a set are 1, then TPC_cmd=1;

If all five hard decisions within a set are 0, the TPC_cmd=−1;

Otherwise, TPC_cmd=0 in the fifth slot.

Algorithm 3:
Assuming N is any non-zero integer,
For the first N-1 slots of a set of N slots, TPC cmd=0.
For the fifth slot of a set:

If all N hard decisions within a set are 1, then TPC cmd=1

If all N hard decisions within a set are 0, the TPC cmd=−1

Otherwise, TPC cmd=0 in the Nth slot
Selection of the value of N depends on the status of AS_state.

Use of the above algorithms may depend on the configuration from a higher layer, as well as on the control signal AS_state that indicates whether the WTRU is in probing or operation mode.

With the TPC_cmd derived, the DPCCH power may be adjusted as shown in Equation 1:

$${P}_{DPCCH\_new} = \{ \begin{matrix}{P}_{DPCCH\_old} + {Δ}_{TPC} \times TPC\_cmd & if power\_update = 1 \\ {P}_{DPCCH\_old} & if power\_update = 0\end{matrix} \qquad ( Equation 1 )$$

where P_{DPCCH}_{_{—}}_{old} is the DPCCH power value stored in the memory from the previous slot. Δ_{TCP} is the step size of the power updating, which should be made adjustable based on AS_state outputted from the switching control unit.

From Equation 1, P_{DPCCH} may not be updated when the associated antenna is not transmitting. This may be implemented via the switch controlled by power_update, as shown in FIG. 7. Note that power_update is a delayed version of AS_cmd that may be set to 1 when switching to the antenna associated with the gain control unit occurs. This delay may be set to take into account the latency introduced by TPC command feedback. AS_state and AS_cmd may be the control signals outputted from the switching control function.

P_{DPCCHO} may be defined as the calibrated DPCCH power obtained with g=1. The gain factor for current time slot may be calculated in Equation 2 in order to achieve the given power target specified by P_{DPCCH}:

$$g = \sqrt{\frac{{P}_{DPCCH}}{{P}_{DPCCH 0}}} \qquad ( Equation 2 )$$

With a dual antenna switching system, two of such power control blocks may be required as indicated in FIG. 5 Use of the gain factors, either g1 or g2, is switched in a TDM fashion correspondingly whenever the antenna switching occurs.

The delayed updating mechanism, the adjustable step size Δ_{TCP}, and selection of the TPC command generation algorithms based on the AS states, may accommodate the need to accelerate the stabilization of the power control loop, especially in the presence of discontinuities caused by the antenna configuration changes. Note that the proposed approach may apply to both TPC-based and closed-loop antenna switching technologies.

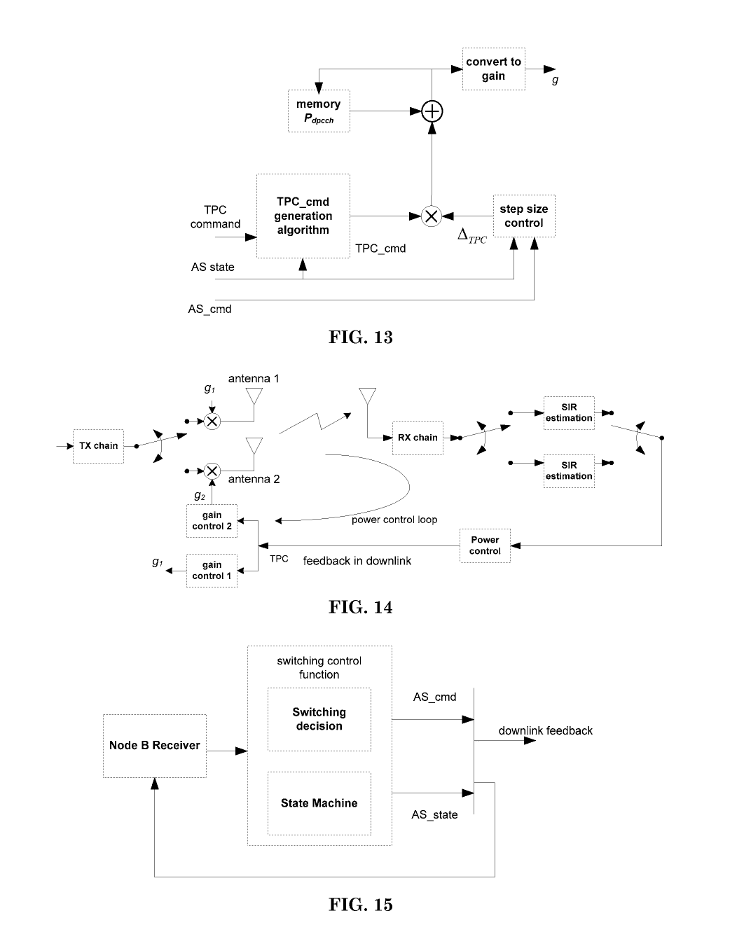

The gain control function may be implemented by a common gain applied to both antennas. The power control algorithms described above are still valid, except that the power_state variable may not be used so that gain is updated constantly as long as the TPC command is received. The implementation of the common gain function is illustrated in FIG. 12 and FIG. 13. Note that the step size may be controlled jointly by AS_state and AS_cmd.

Methods of improving convergence of the uplink power control loop are disclosed that may alleviate the impact caused by action of antenna switches. The states of the power control loop for each of the antennas may be stored separately. When switching of an antenna occurs, rather than continue with settings from the previous antenna, the ones stored in the memory for the current antenna may be used. Though it is still seeing one stream of TPC commands in time, virtually, two control loops may be in operation, one for each antenna. This concept may be implemented with the gain control function structure shown in FIG. 7 at the UE, where two gain factors are alternatively used depending on the antennas. At the Node B side, two sets of measurements may be necessary in alternate use corresponding to the implementation at UE. An example implementation of the concept of virtual power control loop is illustrated in FIG. 14, where g1 and g2, SIR1 and SIR2 are two sets of settings that may be used independently for each of antennas.

The switching control function for TPC-based AS may be implemented at the UE, via a state machine (such as the state machine of FIG. 8) that may control the switch timing and coordinate the operation of other functional processing blocks in the system. The design of the state machine may consider the need for quickly exploring the channel conditions of the two different antenna paths and fast stabilization of the power control loop in the probing mode and maximizing the performance gain for uplink transmission in the operation mode.

As shown in FIG. 8, the outputs of the state machine (which may be included in a switch control function) may include two signals. AS_cmd is a binary control signal that provides switching control to the two antennas: if AS_cmd=0, switch on antenna 1, and switch off antenna 2, and, if AS cmd=1, switch on antenna 2 and switch off antenna 1. AS_state is a status signal that may indicate whether the WTRU should be in probing mode or operation mode.

The switch control function may monitor the status of the gain control function, in order to adjust its state machine accordingly to accelerate the convergence of the power control loop.

For closed loop AS, the switching control function may move to the Node B side although there may still be a remaining part at the UE to assist the operation.

As shown in FIG. 15, an example switching control function at the Node B may include two sub-functions: a decision unit and a state machine.

The direct access to the uplink receiver by the switching control function at the Node B may allow more effective antenna switch control and quicker reaction to the change of the channel conditions. The information provided from the uplink receiver may include one or any combination of the following: channel estimation results; SIR or SINR; BLER; estimated receive power (e.g., Rx signal power at the NodeB); or, estimated UE speed/Doppler shift.

Based on one or a combination of these information inputs, the switching function may decide which antenna to use for transmission at the UE in order to minimize the power usage at the UE transmitter, optimize the uplink reception performance, etc.

The state machine may optimize the antenna selection/search process via appropriate control of the probing and operation modes. Probing phase details may follow.

The control signals supplied by the switching control function at the Node B, such as the antenna control commands or probing mode status, may be sent to the UE via the downlink signaling. It may be beneficial to forward the information to the receiver at the Node B as well so that it may adapt its receiving algorithm to mitigate the transition impact of the antenna status changes.

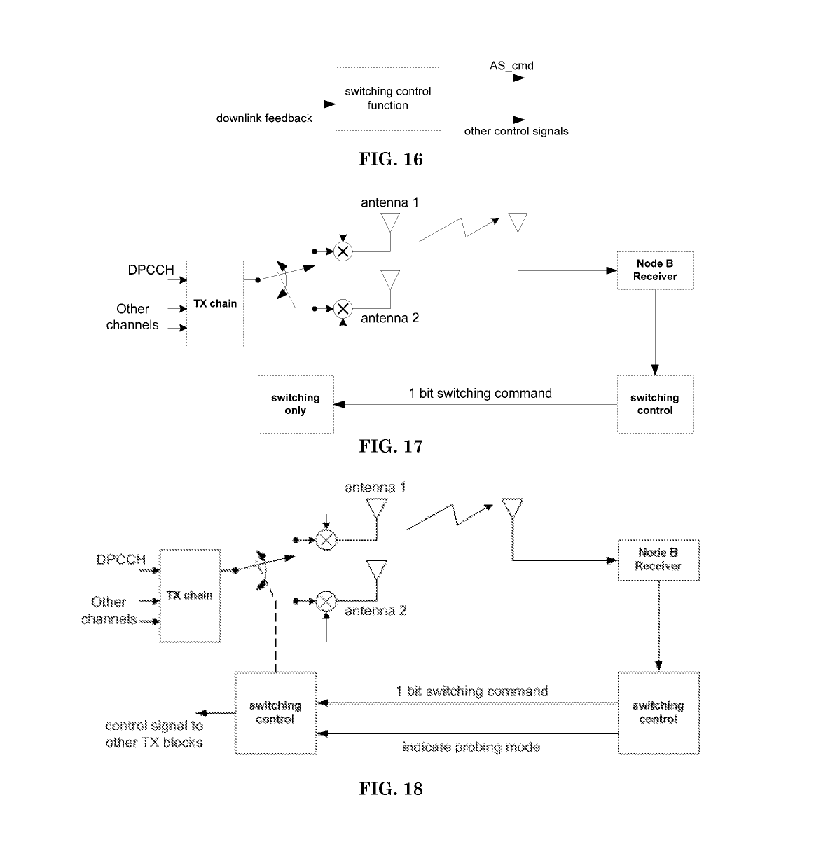

The switching control function at the UE may be a switch structure that alters the transmit signal to different antennas or it can be designed to provide some control signals to some of the transmitter functions to improve the uplink transmission, particularly in probing mode, during which the system may need to be promptly stabilized from the transition due to frequent antenna switches. The functional block diagram of switching control function at the UE is shown in FIG. 16.

For closed loop AS, the Node B may feedback some of the raw information from the Node B receiver as listed above to the switching control function residing in the UE by downlink signaling. This may allow the UE to make a decision on the antenna selection in order to optimize the macro diversity gain in soft handover (SHO) mode. Transmission of this information to the UE may be limited to the SHO mode.

AS may be fully controlled by the Node B. As shown in FIG. 17, 1 bit of signaling may be sent to the UE from the Node B regularly, e.g., on a per TTI basis, per radio frame basis, etc. The state of this bit may indicate which antenna to use for transmission. For example, 0 indicates that antenna 1 is switched on and vice versa for antenna 2. The 1 bit signaling may be limited to the time the switch action takes place. This may be carried as an HS-SCCH order or in other downlink control channels. Other examples may include using the F-DPCH, E-HICH/E-RGCH encoding schemes and format to carry the information.

In this case, it may be Node B's responsibility to monitor the channel and signal conditions at its receiver and initiate the probing mode appropriately to control the antenna switching. In this mode of operation, the UE is in a slave mode by executing the switch order according to the signaling bit. It may not have direct knowledge when the probing mode occurs and thus does not have to account for the uplink receiver loss caused by switching transition. An example implementation is illustrated in FIG. 17.

AS may be Node B controlled with assistance from the UE. In this case, in addition to the 1 bit switching command signaling as described above, it may be useful to inform the UE of the use of the probing mode via additional signaling. The additional signaling may be carried by adding one more bit or multiple bits in any of the downlink control channels, such as an HS-SCCH order. The UE may determine the probing mode autonomously, e.g., by timer based implementations.

In the signaling based case, the feedback signaling may explicitly indicate the beginning and ending of the probing mode.

For the probing mode with constant TX power as described herein, the feedback signaling may consist of one or any combination of the following:

one bit indicates the beginning of the probing mode;

one bit indicates the ending of the probing mode;

one bit flag indicates whether to enable the control TX power constant mode or not. When receiving the enabling flag of control TX power constant, the UE may not transmit data during the period that TX power is controlled to be constant as it may imply the ULPC is off if it is not desired to have performance degradation due to it.

In the timer based case, the feedback signaling may be limited to indicating the beginning of the probing mode. Then, a timer may be started in the switching control function at the UE, and, upon its expiration, the probing mode may be deemed to be ended per agreement between the UE and Node B. Timer length may be pre-defined or pre-configured by the network via RRC signaling. This way of signaling may help to reduce the signal overhead, but may impact flexibility.

Being better informed, the switch control function at the UE may generate control signals to adjust some of processing blocks at the transmitter side to mitigate the impact of the transition, and thus reduce the receiver loss at the Node B. For example, the step size of the power control loop may be altered accordingly to speed up the convergence of power control loop. FIG. 18 illustrates an example of the Node B controlling AS with assistance from the UE. Additional details are described below.

The UE may control AS. In this case, the switch decision may be left to the UE. The UE may need to be informed about the channel and signal conditions at the Node B receiver, e.g., through the downlink feedback. Information that may be useful to assist the decision of the UE may include true values or differential values about one or more of the following measurements: channel estimation results, SIR, BLER, estimated receive power, or UE speed.

As a result, the switching control function at the UE may be responsible for the AS operation while the corresponding part at the Node B may have minimal design.

This implementation may impose a large downlink overhead. An advantage may be that the macro diversity gain may be optimized in the soft handover (SHO) scenario because the UE may combine the information received from various cells comprising the active set/E-DCH active set and make an appropriate decision.

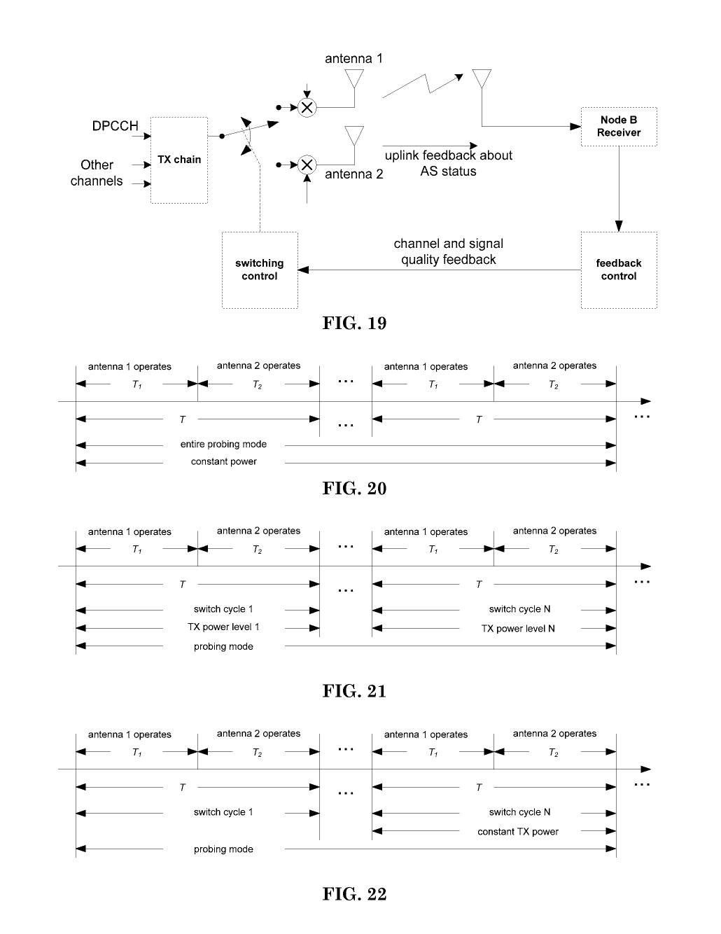

The status of the switch may be fed back to Node B via addition uplink signaling. The additional uplink feedback may include information about which antenna is being used for transmission and/or when the probing mode is taking place. FIG. 19 illustrates an example of the UE controlling AS.

A probing mode is disclosed that may provide information about transmission quality relating to the antennas. The probing mode may use a predefined pattern, e.g., as illustrated in the example of FIG. 9. In this case, the data transmission may operate alternately between the two antennas with a pre-defined pattern. Channel conditions may not be taken into account in the operation.

Let T₁ denote the time interval when antenna 1 is switched on while antenna 2 is turned off, and T₂ be the time interval when antenna 2 is switched on while antenna 1 is off The total duration of one switch cycle, T, is the sum T=T₁+T₂ as shown in FIG. 9. The unit of the time intervals may be time slot, TTI, or radio frame.

The probing mode may last for one or a number of switch cycles, which may be predefined or configured by the network.

The switch pattern may be defined in different ways within a single switch cycle. For example, there may be an equal duty cycle for the two antennas. There may be an unequal duty cycle for the two antennas, e.g., T₁/T₂ is set to a constant ratio. This ratio may be pre-defined or preconfigured, or controlled by the statistics obtained from the downlink receiver that uses the same antennas. There may be an unequal duty cycle, e.g., T₁/T₂ is variable over different switch cycles. For instance, it may sweep different ratios among the two extremes over time.

The length of the switch cycle, T, may be selected with one or any combination of the following: always constant, where it may be predefined or configured by the network via RRC signaling; choosing a large value, and gradually reducing the value when the power loop is getting to steady state (that is, the switch rate is made very slow at beginning and becomes faster at end of the probing phase); periodically varying the length of T until the end of the probing phase; or, randomly varying the length of T until end of the probing phase.

It may be possible to add a guard interval between switching of the antennas as shown in the example of FIG. 10. During the guard interval, there may be no transmission in either of the antennas. The guard interval may be designed as: a constant Tg over the whole probing phase, which may be predefined or configured by network via RRC signaling; or, a gradually reducing Tg such that at the end of the probing phase it may be diminished to zero.

The probing mode may be used with multiple predefined patterns depending on some considered factors such as data traffic status, fading channel conditions, etc. For example, depending on the granularity of the speed chosen based on the implementation complexity, M predefined pattern T(m) may be defined corresponding to M pre-defined speed targets V(m), where m=1, 2, . . . , M. T(m) may be the same (which may fall back to the method described above) or different (for example, with the increase of V(m), the corresponding T(m) may be selected to be shorter). If the current estimated speed is between V(m−1) and V(m), then the predefined pattern T(m) may be used for the coming probing mode. Furthermore, the definition of T1(m)/T2(m) within T(m) may use any of the above in common or independently. Similarly, guard interval Tg(m) may be used independently or common for the M pre-defined pattern.

The probing mode may use a variable pattern. Power control loop stability may need to be considered. Upon switching of antenna, a sudden jump of received power may occur at the Node B receiver due to channel path change. Therefore it may be desirable to have the power control loop be stabilized when comparing the channel and signal condition of two antenna paths. As one example, let Nd be the number of TPC commands requesting a decrease of the UE TX power, and Nu be the number of TPC commands requesting an increase of the UE TX power, both of which may be measured during a specific time (e.g., in terms of time slots, sub-frames, or radio frames). Nd and Nu may be roughly equal if the power control loop is approaching stable. The antenna switching may be triggered according to following condition:

aₘᵢₙ<N₁/N₂<aₘₐₓ

where aₘᵢₙ<1 and aₘₐₓ>1 are constants around one, which may be predefined and preconfigured.

The SINR (or SIR) stability may need to be taken into account. It may be desirable to have SINR estimation at the Node B receiver to reach a certain steady state after a switching antenna action was taken. If the SINR estimation result is still varying, either increasing or decreasing, due to settlement of the Node B receiver (e.g., channels estimation, power control loop, or any other factors), the switch of antenna may not occur. As an example, let SINR₁ be the long term average of the SINR and SINRₛ the short term average, the antenna switching may be triggered if following condition consecutively (or with majority) occurs over a number of radio frames (or sub-frames):

aₘᵢₙ<SINR₁/SINₛ<aₘₐₓ

where aₘᵢₙ<1 and aₘₐₓ>1 are constants around one, which may be predefined and preconfigured. BLER may help to judge if SINR reaches steady state. For example, let BLER₁ be the long term statistics of the BLER and BLERs the short term statistics. The antenna switching may be triggered if following condition consecutively (or with majority) occurs over a number of radio frames (or sub-frames):

aₘᵢₙ<BLER₁/BLERₛ<aₘₐₓ

where ₐₘᵢₙ<1 and aₘₐₓ>1 are constants around one, which may be predefined and preconfigured. Note that this may be used when the UE is not necessarily in probing mode as well as it depends on data being transmitted. The BLER measurement may be the HARQ BLER or the residual BLER which is available at the RNC for the soft handover case:

It may be desirable to have uplink receive power estimation at the Node B receiver to reach a certain steady state after a switching antenna action was taken. If the receive power estimation result is still varying, either increasing or decreasing, due to settlement of the power control loop, the switch of antenna may not occur. Let P₁ be the long term average of the receive power and Ps the short term average, the antenna switching may be triggered if the following condition consecutively (or with majority) occurs over a number of radio frames (or subframes):

aₘᵢₙ<P₁/Pₛ<aₘₐₓ

where aₘᵢₙ<1 and aₘₐₓ>1 are constants around one, which may be predefined and reconfigured.

The probing mode may start from the time of switching to a second antenna while it has operated for a period of time on a first antenna. If the Node B is receiving a sign from the measurement that the antenna under probing is worse, it may decide to end the probing mode and switch back to the previous antenna. Otherwise, it may stay with the current antenna. The measurement under watch during the probing mode may be SINR, receive power, channel estimation results, power control loop status, etc.

To prevent probing duration staying on one antenna for too long, a maximum duration parameter Tmax may be defined. A timer may be set to Tmax at the time an antenna is switched on. If the receiver has not reached steady state according to one of above proposed criterions by the time the timer expires, a switch to another antenna may be triggered.

As a hybrid of predefined and variable patterns, T1 may be chosen to be fixed and T2 may be variable depending on measurement of the signal quality and channel conditions, or vice versa.

The probing mode may use constant TX power. Due to dynamic nature of the power control loop, it may not be possible to have the same transmit power at the time the measurement is taken for each antenna in the probing mode. Thus, it may increase difficulties for Node B to make a fair comparison between the antennas. One or more of the following may be implemented.

The UE may be constrained to freeze the power control loop to have the UE transmit at a constant power during the entire probing phase. The UE may take the TX power level at the time it enters the probing mode and maintain it to be constant in the probing mode. An example of freezing the power control loop is illustrated in FIG. 20. A possible disadvantage of this implementation is that it may impact the transmission quality if uplink data is sent during this period.

A constant TX power may be maintained within a switch cycle if the probing mode comprises multiple switch cycles, e.g., as illustrated in the example of FIG. 21. The TX power may be allowed to vary on a per-switch-cycle basis. To mitigate the impact on the uplink data transmission, the switch cycle duration, T, may be configured to a small value, e.g., a quick switch pattern is desired.

A constant TX power may be maintained at any of predefined or configured switch cycles. One example is shown in FIG. 22, where the last cycle is restricted to have constant TX power.

Instead of constant TX power during probing mode, a smaller step size may be chosen for the uplink power control procedure so that the Node B may keep track of the TX power changes from the TPC commands it issued. To ensure accuracy of the power tracking, the UE may be required to follow each TPC command it receives during the probing mode.

A decision on when to start the probing mode may need to be made. Along the operation of the switched antenna TX diversity over the time, it may be necessary to go back to the probing phase to improve performance, e.g., for fast changing channel conditions. With regards to when to apply the probing mode, one or more of the following may apply. Apply the probing phase initially. After that, the power control loop status in the operation mode may be relied upon to adapt the antenna switch pattern. The probing mode may be applied periodically as controlled by a pre-configured timer. The probing mode may be controlled by gain factors, gi and g1. If one of them is not stable, the probing mode may be initiated. This may be limited to when the UE initiates the probing mode. Starting of the probing mode may be based on traffic statistics. If data has a bursty nature, the probing mode may be applied when the data traffic is not busy. Starting of the probing mode may be based on HARQ retransmission statistics. If a large number of retransmission requests are seen, the probing mode may be initiated.

The initiation made on the Node B may be based on one or a combination of the following factors: the Node B receiver senses increasing and/or constant needs to ask for raised UE transmit power from the uplink power control loop, the Node B receiver is experiencing excessive HARQ failure, the Node B receiver is experiencing noticeable SINR decrease, the Node B receiver is experiencing noticeable BLER increase, the Node B receiver is experiencing noticeable received DPCCH power decrease, the Node B receiver senses a sudden UE speed change or gets notified about this event from the UE measurement report.

During the probing mode, measurements may be made individually when each of the antennas is operating. For closed loop AS, the Node B may have direct access to the uplink receiver and channel estimation results. Multiple measurements may be made and recorded during the time when each component of the uplink receiver is considered to be stabilized from the transition caused by switching antennas. At the end of probing mode, two sets of measurements may be available for the Node B to make a decision which antenna to use in the operation mode.

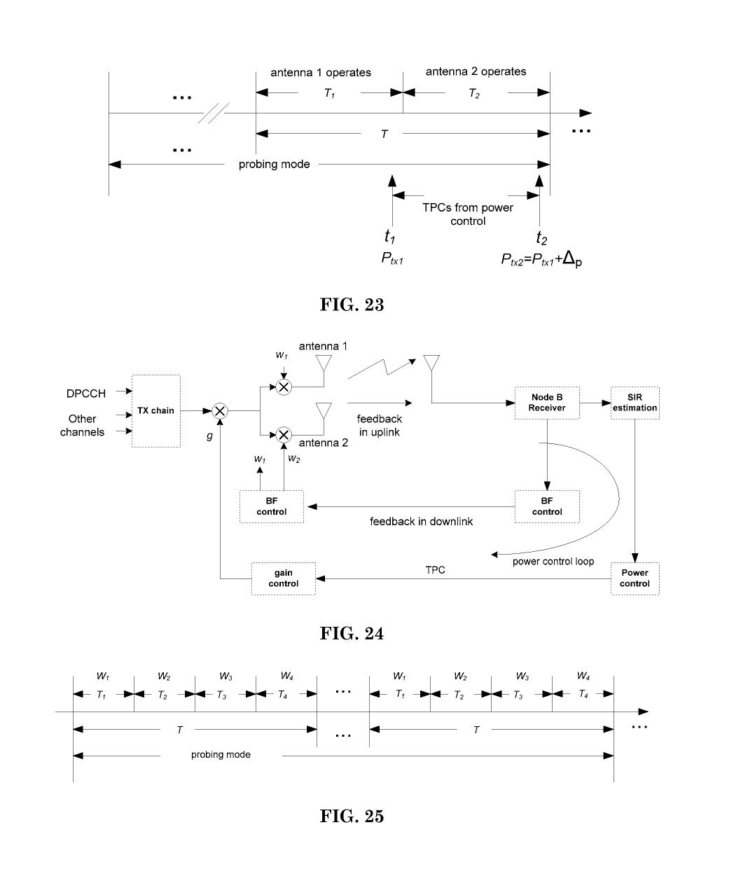

In the example of FIG. 23, the measurement for antenna 1 is recorded at t₁, and the measurement for antenna 2 is recorded at t₂. t₁ may be different than t₂ because the measurements are taken during the period in which the associated antenna is operating. If the uplink power control procedure is in operation, the UE TX power may be dynamically adjusted in the duration from t₁ to t₂. This variation of UE TX power needs to be compensated for by an offset when comparing the two measurements. Otherwise, it may become difficult to compare the measurements accurately.

The UE TX power variation may be denoted as Δp, which may be tracked by the Node B, e.g., if it records each of the TPC commands it has issued to the UE in DPCCH or in FDPCH during t₁ to t₂, for example:

$${Δ}_{p} = {Δ}_{TPC} \cdot {\sum }_{{t}_{1} to {t}_{2}} {TPC}_{i} ( dB )$$

where Δ_{TPC} (in dB) is the step size used in the uplink power control procedure and TPCi are the TCP commands issued during t₁ to t₂ per time slot. Adjustments may need to be made for the latency of the power control loop around the boundary of t₁ or t₂.

The tracked TX power variation may be used as the power offset in the comparison. If it is known that the UE is adopting constant TX power options for the probing mode, e.g., as disclosed herein, the power offset Δp may be set to 0.

When the UE is in SHO, for the purpose of probing, the UE may ignore the TPC commands from non-serving Node Bs (or equivalently from the radio links outside of the radio link set of the serving Node B). This may allow the Node B to estimate the power variation as it has full knowledge of the TPC commands transmitted to the UE.

The Node B may use average SINR to decide which antenna to use in the operating mode. SINR1 may be denoted as the Signal to Interference and Noise Ratio for antenna 1, and SINR2 for antenna 2, if SINR1>SINR2−Δp, select antenna 1. Otherwise select antenna 2. SINR may be expressed in terms of dB.

The Node B may use average receive power to decide which antenna to use in the operating mode. P1 may be denoted as the received power at the Node B receiver while antenna 1 is operating, and P2 while antenna 2 is operating, if P1>P2−Δp, select antenna 1. Otherwise, select antenna 2. Received power may be expressed in terms of dB.

The Node B may use channel estimation to decide which antenna to use in the operating mode. h1 may be denoted as the uplink composite channel estimation result while antenna 1 is operating, and h2 while antenna 2 is operating. If 20 log 10(|h|)>20 log 10(|h2|)−Δp, select antenna 1. Otherwise, select antenna 2.

The Node B may use power control to decide which antenna to use in the operating mode. If Δp>0 select antenna 1. Otherwise select antenna 2.

The Node B may use BLER to decide which antenna to use in the operating mode. BLER1 may be denoted as the block error rate (e.g., HARQ BLER) for antenna 1 during period T₁, and BLER2 for antenna 2 during period T₂. If BLER1<BLER2, select antenna 1. Otherwise, select antenna 2. To get an appropriate assessment of BLER, use of the probing mode with constant TX power as described herein may be recommended.

Actions to mitigate performance loss may be taken. While probing the channel conditions of each antenna path via stabilizing the power control loop, the probing mode may still carry the task of data transmission. The discontinuities due to switching between the antennas, and the abrupt propagation path change may impact the uplink data transmission quality.

One or more of the following may be implemented to mitigate performance loss during the probing mode: allocating more transmit power to the E-DPCCH to assist channel estimation in the base station, allocating more transmit power to the E-DPDCH to increase the reliability of high speed data transmission, or changing the power loop algorithm to speed up convergence of the power control loop. For example, the step size of the power control loop may be adjusted, data allocation in the E-TFCI selection may be reduced, the number of HARQ retransmissions may be increased, different RV and rate matching settings may be used, etc.

One or more of the following may apply to the transmitter at UE side. When the UE is informed about the probing mode, such as in the implementation of either UE controlled or assisted AS as described herein, the above may be readily implemented. In the fully Node B controlled AS, however, the UE may not be aware of use of the probing mode because there may be no dedicated signaling for the probing mode. In this case, the UE may autonomously apply the methods based on its observation.

When a switch to another antenna occurs, one or more of the following examples may apply for the next number of radio frames (or sub-frames, or time slots).

If the switch frequency, which may be measured by the number of switches during a given frame of time, exceeds a predefined or preconfigured threshold, apply one of above methods for a certain duration of time, which may be measured in terms of radio frames, sub-frames, or time slots. The length of duration can be predefined or configured by the network.

If two switches are commanded in a time interval smaller than a predefined or pre-configured threshold, apply one of the above methods starting from the second switch for the next number of radio frames (or sub-frames, or time slots).

The triggering criterions for initiating the probing mode disclosed herein may be applied individually or jointly in any form of combination.

When the probing mode is over, the WTRU may be switched to the operation mode in which normal data transmission may be carried out. In this mode, the WTRU may assume that the UL control loop has already reached steady state. Thus, the antenna switch pattern may be decided adaptively in accordance with the DPCCH gain factors from both antennas.

The antenna switch pattern in the operation mode may be designed with one or more of the following: if g₁>g2, complete shut off antenna 1 and vice versa; if g₁>g2, make T₁ as small as it can be to maintain the power control loop, and vice versa; set the duty cycle ratio approximately equal to the gain ratio: T₁/T₂≈g₂/g₁; or set the duty cycle ratio approximate equal to the power ratio: T₁/T₂≈g₂²/g₁².

As the DPCCH gain factor varies over the time, the antenna switch pattern may be changed accordingly in terms of the above or any combination of the above.

Uplink transmission may be performed with beam forming TX diversity. The concept of the probing mode may be applied to single-pilot beam forming (BF) transmit diversity schemes as shown in FIG. 24 where the DPCCH carrying the pilot is transmitted in both antennas. Precoding weights, denoted by w₁ and w₂, may be applied to each of the antennas respectively, e.g., which may minimize the UE TX power or similarly improve uplink transmission quality.

For closed loop BF, a downlink signaling link may be required to carry the feedback information sent by the Node B, following which the UE controls the use of the precoding weights.

The BF control function as shown in FIG. 24 is introduced to find optimal precoding weights to achieve the desired performance objective. It consists of two parts residing on UE and/or Node B inside which different functionalities may be implemented.

The following may apply to probing mode design. To simplify implementation, a codebook with a limited number of entries may be defined for the precoding weights. For example, w₁ and w₂ may have the following 4 possible vector values:

$$[ \begin{matrix}{w}_{1} \\ {w}_{2}\end{matrix} ] = \{ [ \begin{matrix}1 \text{/} \sqrt{2} \\ \frac{1 + j}{2}\end{matrix} ] , [ \begin{matrix}1 \text{/} \sqrt{2} \\ \frac{1 - j}{2}\end{matrix} ] , [ \begin{matrix}1 \text{/} \sqrt{2} \\ \frac{- 1 + j}{2}\end{matrix} ] , [ \begin{matrix}1 \text{/} \sqrt{2} \\ \frac{- 1 - j}{2}\end{matrix} ] \}$$

The antenna switching may be considered as a special case of the BF, where two precoding vectors are used:

$$[ \begin{matrix}{w}_{1} \\ {w}_{2}\end{matrix} ] = \{ [ \begin{matrix}1 \\ 0\end{matrix} ] , [ \begin{matrix}0 \\ 1\end{matrix} ] \}$$

Denote N as the number of the precoding vectors in the codebook, and Ti, i=1,2, . . . , N as the lengths of probing states during which the individual precoding vectors may be used respectively for transmission. The methods of either fixed or variable probing patterns described herein may be applicable to the cases with multiple probing states if considering the difference that in each switching cycle, Ti, i=1,2, . . . , N may be arranged either consecutively or randomly (but with a predefined pattern). For example, an example fixed pattern probing mode is show in FIG. 25, where N=4 and W1, W2, W3, W4 represent the precoding vectors that are used in each of probing states respectively.

The concepts of constant TX power described herein, and initiating the probing mode described herein, may be applicable here. The difference is that the antennas may be replaced by the precoding vectors.

For a Node B controlled probing mode, log 2(N) bits of signaling is generally needed for the downlink feedback, from which the Node B may need to send a command to instruct which precoding to use.

During the probing mode, measurements may be made individually when each of the precoding vectors is used. At the end of probing mode, N sets of measurements may be available for the Node B to make a decision which precoding vector to use in the operation mode, where N is the number of precoding vectors in the precoding codebook.

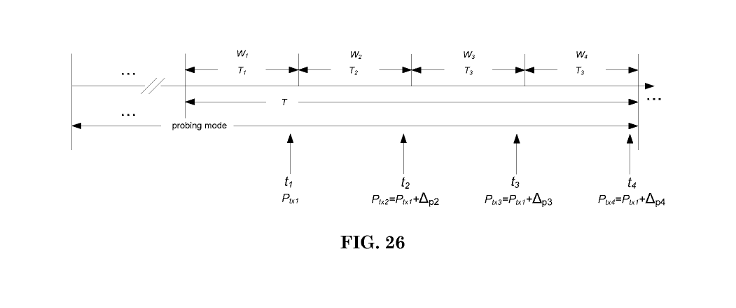

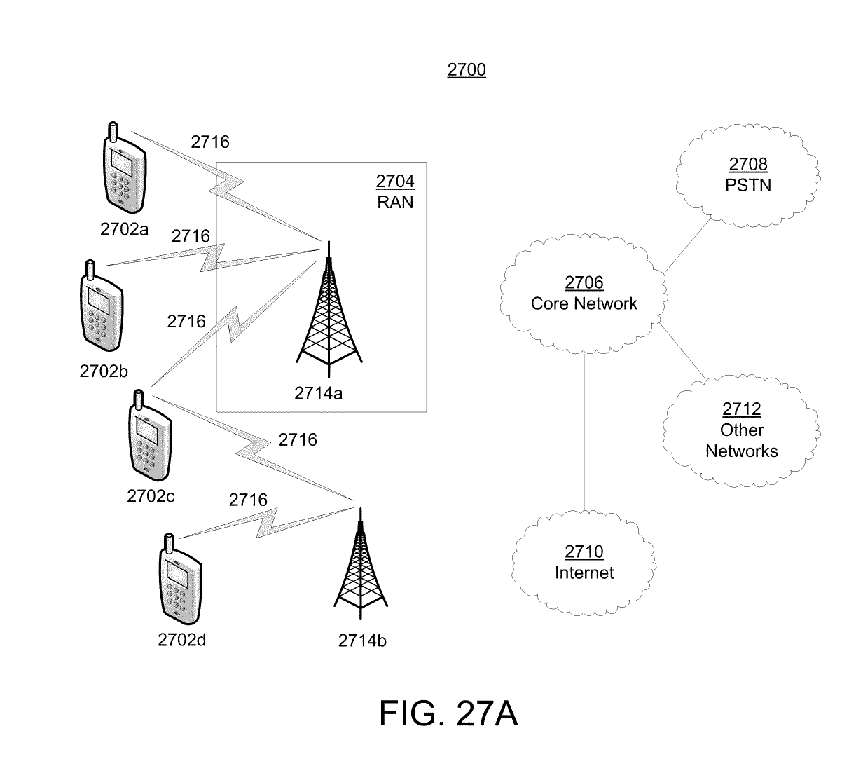

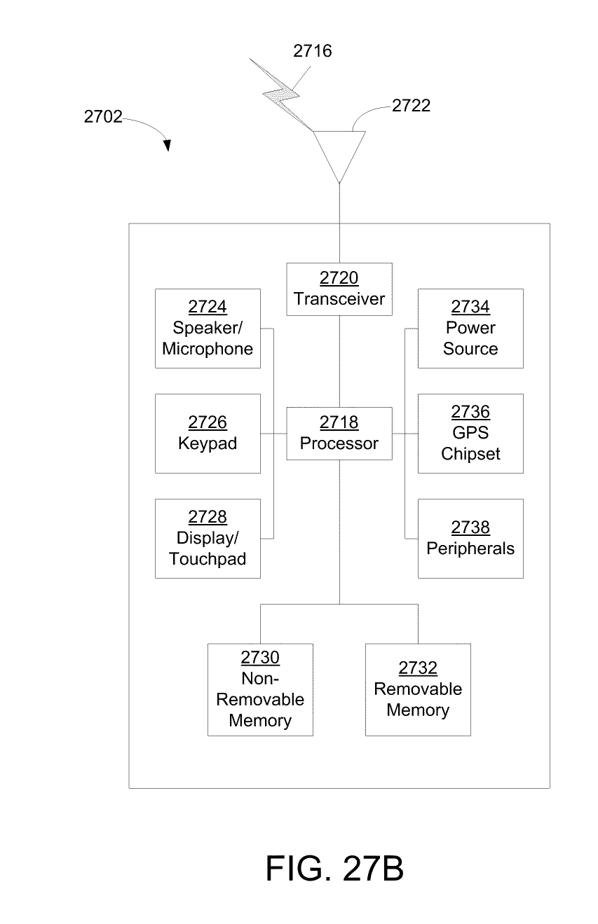

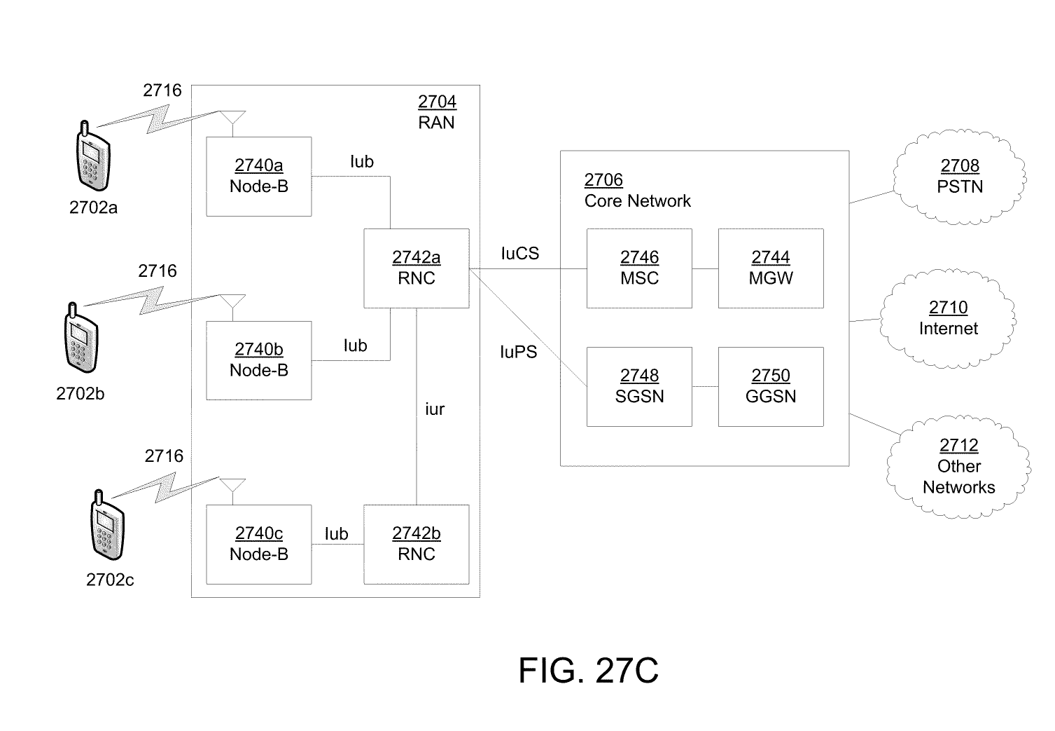

Assume the measurement for each of the precoding vectors w, is recorded at tᵢ, i=1, 2, . . . , N, respectively, as shown in FIG. 26 for N=4. tᵢ may not coincide with each other because the measurements may have to be made during the period in which the associated precoding vector is operating. If the uplink power control procedure is in operation, the UE TX power may be dynamically adjusted in the duration from t₁ to t_{N}. This variation of UE TX power may need to be compensated for by an offset when comparing the two measurements made for each of the precoding vectors. Otherwise, the resulting measurements may be difficult to use.

Similar to the antenna switching technology, the Node B may track the power variable if it keeps a record of each TPC command it has issued to the UE in DPCCH or in F-DPCH, during t₁ to t_{N}. The power variable for each of the precoding vectors may be estimated by:

$${Δ}_{pi} = {Δ}_{TPC} \cdot {\sum }_{n ∈ {t}_{1} to {t}_{i}} {TPC}_{n} ( dB ) , i = 1 , 2 , … , N$$

where Δ_{TPC} (in dB) is the step size used in the uplink power control procedure and TPCn are the TCP commands issued during t₁ to t_{N} per time slot. Note that Δp₁=0, and, adjustments may need to be made for the latency of the power control loop around the boundary of t₁ or t_{N}.

These tracked TX power variations may be used as the power offset in the comparison of the precoding vectors. If it is known that UE is adopting constant TX power options for the probing mode as disclosed herein, the power offset Δpᵢ may be set to 0.

Similar to the switch antenna case, it may be desirable for the UE in SHO to ignore the TPC commands from non-serving NodeBs during the probing mode. This may allow for more accurate estimation of the UE transmit power.

Let X be the performance measurements in dB that may be chosen by the Node B as the performance metric to decide the optimum precoding vector. For example, X may represent the received power, SINR, or channel estimation results. The decision may be based on the following criterion. The ith precoding vector is selected if:

i=arg(max(X_{1.} X₂−Δₚ₂, . . . , X_{N}−Δ_{pN}))

If power control status is considered as the performance metric, the following may be used. The ith precoding vector is selected if

i=arg(min(Δₚ₁,Δₚ₂, . . . ,Δ_{pN}))

If BLER status is considered as the performance metric, the following may be used. The ith precoding vector is selected if

i=arg(min BLER₁,BLER₂, . . . , BLER_{N}))

Note that use of the probing mode with constant TX power may be desirable in this case.

At the end, the Node B may need log 2(N) bits of downlink signaling to notify the UE which precoding vector is used for the operation mode.

In order to support operation of the uplink transmit diversity, control and signaling procedures may be established.

An enabling/disabling mechanism that may allow or disallow UL diversity operation is described herein. This function may make it possible to provide control or information exchange from either the network or WTRU side.

A number of activation/deactivation implementations are disclosed that may optimize the system gain of TX diversity and reduce its impact to other uplink transmission procedures.

The network may be the initiator. In this case, the network may send a control signal to the WTRU to enable/disable the transmission diversity operation. Implementations may be explicit or implicit as described herein.

Explicit implementations may include one or more of the following. The UE may receive UL transmit diversity configuration via RRC signaling, e.g., when it connects to the network or when it is moved to CELL_DCH operations. The UE (capable of UL transmit diversity) may be limited to using UL transmit diversity when explicitly allowed by the network (default is to not use UL transmit diversity). The UE may be capable of UL transmit diversity and use UL transmit diversity unless explicitly denied by the network (default is to use UL transmit diversity if supported). When the UE is allowed to use UL transmit diversity it is said to be enabled, whereas when it is not allowed to use UL transmit diversity it is said to be disabled.

For unconnected UEs, the network may broadcast whether or not UEs are allowed to use UL transmit diversity on the SIBs.

Faster activation/deactivation mechanisms may be used when UL transmit diversity is enabled (that is, a set of implementations in addition to the RRC signaling approach enabling UL transmit diversity).

The Node B may be allowed to disable/enable the TX diversity operation via Layer 1 signaling, which may be a HS-SCCH order or new L1 signaling. A new HS-SCCH order may be defined to dynamically configure the WTRU to allow or disallow the TX diversity operation. Upon reception of the enabling order, the WTRU may interpret that it can start the TX diversity operation for the intended performance enhancement. Upon reception of the disabling order, the WTRU may stop the operation, e.g., immediately or within the specified time frame.

The HS-SCCH order signaling may be implemented, for example, by using the following, where the Order Type bits are labeled Xodt,1, Xodt,2, Xodt,3 and the Order bits are Xord,1, Xord,2, Xord,3:

If Order type Xodt,1, Xodt,2, Xodt,3=‘001’ then the mapping for Xord,1, Xord,2, Xord,3 is as follows:
Xord,1, Xord,2, Xord,3 is comprised of:
   Transmission diversity enabling (1 bits): Xord,1=Xtxd,1
   Secondary serving E-DCH cell activation (1 bit): Xord,2=Xsecondary,2
   Secondard serving HS-DSCH cell activation (1 bit): Xord,3=Xsecondary,1

If Xsecondary,1=‘0’, then the HS-SCCH order is a Secondary serving HS-DSCH cell De-activation order.

If Xsecondary,1=‘1’, then the HS-SCCH order is a Secondary serving HS-DSCH cell Activation order.

If Xsecondary,2=‘0’, then the HS-SCCH order is a Secondary uplink frequency Deactivation order.

If Xsecondary,2=‘1’, then the HS-SCCH order is a Secondary uplink Activation order.

The combination Xsecondary,2, Xsecondary,1=‘10’ is a combination used for uplink transmit diversity:
If Xtxd,1=‘0’, then the HS-SCCH order is an uplink transmit diversity disabling order.
If X_{txd}=1’, then the HS-SCCH order is an uplink transmit diversity enabling order.

A new order type may be dedicated for this purpose. For example, this may be implemented as follows:
If Order type Xodt,1 Xodt,2, Xodt,3=‘010’, then the mapping for Xord,1, Xord,2, Xord,3 is as follows:
Xord,1, Xord,2 Xord,3 is comprised of:
   Reserved (2 bits): Xord,1, Xord,2=Xres,1 Xres,2
   Transmission diversity enabling (1 bit): Xord,3=Xtxd,1

If Xtxd,1=‘0’, then the HS-SCCH order is a transmit diversity disabling order.

If Xtxd,1=‘1’, then the HS-SCCH order is a transmit diversity enabling order.

Xtxd,1 may be assigned to other reserved bits, either to Xres,1 or to Xres,2.

This approach may be advantageous as it has more reserved bits that may allow more than one uplink transmission diversity technology to be configured.

Implicit implementations may include one or more of the following. The WTRU may receive an order from the network that implicitly allows/disallows the use of uplink transmit diversity. In one example, TPC-based uplink transmit diversity may not be used when Continuous Packet Connectivity (CPC) operation is activated. A Release 7 mechanism may define HSSCCH orders that deactivate/activate discontinuous transmission or reception (DTX/DRX). These orders may also serve the purpose of implicit enabling/disabling of uplink transmit diversity. An example implementation is illustrated below:

Let the Order Type bits be labeled as Xodt,1 Xodt,2, Xodt,3 and the Order bits be labeled as Xord,1, Xord,2, Xord,3. Then:

If Order type Xodt,1, Xodt2, Xodt,3=‘000’, then the mapping is as follows:

Xord,1, Xord,2 Xord,3 is comprised of:

If Xdrx, 1=‘0’, then the HS-SCCH order is a DRX De-activation order, and an implicit uplink transmit diversity disabling order.

If Xdrx, 1=‘1’, then the HS-SCCH order is a DRX Activation order, and an implicit uplink transmit diversity enabling order.

If Xdtx,1=‘0’, then the HS-SCCH order is a DTX De-activation order, and an implicit uplink transmit diversity disabling order.

If Xdtx,1=‘1’, then the HS-SCCH order is a DTX Activation order, and an implicit uplink transmit diversity enabling order.

If Xhs-scch-less,1=‘0’ then the HS-SCCH order is a HS-SCCH-less operation Deactivation order, and an. implicit uplink transmit diversity disabling order.

If Xhs-scch-less,1=‘1’, then the HS-SCCH order is a HS-SCCH-less operation Activation order, and an implicit uplink transmit diversity enabling order.

The operation of transmit diversity may continue when the CPC activation orders are received. During the wakeup period when the DTX/DRX gap is over, however, means of improvement may need be provided to ensure the transmit power control loop may be quickly stabilized and the antenna switching/beamforming algorithm may keep track of the channel changes. For this purpose, a longer (e.g., more than 2 time slots or configurable period) uplink DPCCH preamble may be applied prior to the E-DCH transmission. The length of the preamble may be either pre-defined as a fixed value or pre-configured by the network. It may also be made variable with an upper limit contingent upon the convergence of the antenna switching/beamforming algorithm. When transmit diversity is disabled, the length of the preamble may be resumed to the nominal value (2 time slots).

Alternatively, not to initiate the probing mode by the rules described herein or other rules may implicitly disable UL transmit diversity.

Configuring the duration of the probing mode to zero may implicitly disable UL transmit diversity. Taking an example of the probing mode with a predefined pattern, setting the switch cycle to T=0 may implicitly disable UL transmit diversity.

The UE may implicitly activate and deactivate uplink transmit diversity based on the cells in the active set. More specifically, when UL transmit diversity is enabled or configured, the UE may deactivate transmit diversity after reception of an ACTIVE SET UPDATE message that adds one or more radio links that are not in the same radio link set as the serving NodeB. This approach may be desirable as the UE may receive contradicting TPC commands from different radio link sets. In such cases, it may become difficult for the UE to determine the optimal antenna or beam to transmit. The additional radio link set may provide additional gain such that the performance losses due to the deactivation of the UL transmit diversity may be compensated for. The UE may activate UL transmit diversity operations when it receives an ACTIVE SET UPDATE message and the resulting active set may have links limited to the same radio link set.

The UE may be the initiator. The UE may autonomously determine to enable or disable the use of uplink transmit diversity based on information available at WTRU. The WTRU decision may be based on one or more of the following.

If the UE senses that the uplink power control is not stable enough to make a meaningful decision to direct the selection of antennas, it may disable the use of uplink transmit diversity.

This may be accomplished, for example, by observing the TPC commands over a given observation window. If the UE senses, for example from the detection of its downlink Doppler shift, that it is moving too fast for the TPC to be able to track the change of the channels, it may disable the use of the uplink transmit diversity.

If the gain factors of the two antennas in the gain control function stay relatively close to each other, it may disable the use of uplink transmit diversity.

If the UE power head rooms (UPH) measured at each antenna stay relatively close to each other, it may disable the use of uplink transmit diversity.

If the UE moves towards the cell edge and determines it not able to fully take advantage of a soft handover (SHO) due to the transmit diversity feature, it may disable the use of the uplink transmit diversity. This may be accomplished, for example, by comparing the relative CPICH of the various cells in the UE active set.

In cases where the compressed mode is configured, if the UE foresees that the compressed-mode gap is coming, it may disable the antenna switch operation and may turn it on afterward.

If the UE determines that its speed is larger than a certain threshold, it may deactivates UL transmit diversity. Likewise, if it determines that its speed is lower than a certain threshold, it may activate UL transmit diversity. The UE may estimate its speed based on downlink channel measurements (e.g., measuring the Doppler shift, the channel rate of change, etc.). The UE may notify the network by either L1 or higher layer signaling rather than the autonomous activation/deactivation.

If uplink transmission falls in any power ramping mode, such as in PRACH or radio link synchronization phase, transmit diversity may be deactivated.

When uplink transmit diversity is disabled, either triggered by the network or the WTRU, the operation of the uplink transmit may fall back to a non-diversity mode in a number ways, for example: stay with the antenna that was in use previously; or, fall back to a primary antenna that is pre-defined or pre-configured.

If the transmit diversity is beamforming based, one or more of the following may be used: freeze updating the precoding weights and continue to use them for the transmission during the entire disabling period; or, reset the precoding weights to pre-specified values(e.g., equal weights on both of the antennas, or the weights that only allow use one of the antennas).

“Disable the use of uplink transmit diversity” may also be interpreted as being limited to stopping the TPC-directed operation for the dynamic update of the pre-coding weights. The WTRU may still apply a “blind” transmit diversity mechanism that uses a fixed or predefined updating pattern to control the operation of two antennas.

In order to avoid significant impacts on network reception or interference levels after activation or deactivation of TX diversity, power setting implementations for the UL channels during this transient period may be needed. As an illustration, if power ratio settings are maintained during activation/deactivation, one or more of the following may apply.

When the UE is activating N=2 TX diversity, the UE doubles the number of transmit antennas which may lead to a increase in received SIR at the Node B, therefore possibly impacting system noise rise and reducing system capacity/coverage.

When the UE is de-activating N=2 TX diversity, the UE falls back to 1 TX antenna operation, which may lead to a loss in received SLR at the Node B (on top of additional demodulation loss due to the now outdated channel estimate at the Node B). This may adversely affect Node B reception of data and control channels (such as UL feedback of ACK/NACK and CQI on HS-DPCCH).

To provide mitigation, power setting and/or the UE's transmission of certain UL channels may be addressed. One or more of the following may apply for activation and/or deactivation.

A power offset penalty in the case of activation, e.g., one per channel or common across all UL channels, may be applied immediately following activation, so that the resulting temporary increase in interference may be kept at some desired level. A power offset boost, e.g., one per channel or common across all UL channels, may applied immediately following deactivation, in order to increase RX SIR, at the Node B. The duration of this period may be chosen such that enough DL TPC commands are sent such that ILPC stability may be reached.

A common power offset may be applied to channels transmitted by the UE. The duration and value of this power offset penalty may be signaled by: the network via L3 mechanisms such as RRC signaling, using an L2/L1 message for example in a new field of the MAC header, using a new HS-SCCH order carrying this information, etc. The duration and value of this power offset may be fixed, e.g., in specifications. In one such case of this approach, a power offset may be applied to the DPCCH after activation/deactivation. This power offset may be applied once, and the ILPC mechanism may then ensure that the proper power level is reached. There may be no need for a duration value for the offset application as it may be applied once replacing the value of the DPCCH power.

A channel-specific power offset may be applied by the UE. The duration and the additional per-channel power offsets may be signaled to the UE by the higher layers. The UE may be configured with more than one set of channel-specific power offsets that may be used depending on the service class (e.g., depending on the HARQ profile being transmitted). These power offsets may replace the power offset being used by the UE or may be applied on top of the power offset configured.

A transmission back-off period may be used during which no data is sent on the E-DCH, which should be sufficiently long such that ILPC stability is met using TPC commands. A possible advantage of this is further reduced noise rise spikes at the Node B.

The duration of this back-off period may be signaled by the network via higher layers (e.g., RRC signaling). The Node B may signal the duration via L2 and L1 mechanisms (e.g., via a new MAC field or using HS-SCCH orders). The back-off period may be fixed in specifications.

Because the reliability of the HS-DPCCH may be difficult to guarantee during the transition period, the network may not transmit HS-DSCH in the TTIs that would result in the UE transmitting ACK/NACK during the back-off period. When the UE receives DL data, a power penalty during this back-off period may be applied on top of HS-DPCCH. The value of this penalty may be constant or gradually ramp down during the back-off period, e.g., in a predetermined fashion.

Though the base station receiver does not have to be aware of the use of switched antenna TX diversity at the WTRU, it may be beneficial to signal the Node B about the status of the antenna switching operation, such as timing of switching or whether the WTRU is in the probing mode. Being better informed, the base station receiver may adjust its processing accordingly to adapt to the changes. For example, if the Node B knows the WTRU is in the probing mode, it may change the time constant in the SIR average algorithm to assist convergence of the power control loop, or, if the Node B receiver knows the timing at which the antenna switching occurs, it may switch to a pre-stored channel estimate coefficient to accommodate the changes.

Though the proposed signaling methods presented in this section may be described in the context of switched antenna transmission diversity, it is understood that they may also be intended for other transmit diversity techniques whenever applicable, such as TPC-based beamforming.

Upon autonomously disabling/enabling use of the uplink transmit diversity, the WTRU may send an indication to the network to signal the change.

When signaling to the network the status of the uplink transmit diversity, a special or reserved value of the E-TFCI may be transmitted in the UL using the E-DPCCH channel. The WTRU may send the special E-TFCI when there is no data to transmit on this carrier (e.g., E-DPCCH not transmitted). In this case, the bits in other information fields in the E-DPCCH may be available to be configured to deliver different orders for different purposes.

The proposed E-DPCCH indication signaling may be implemented, for example, by using the following method, where the information fields are represented by the following bits:
Retransmission sequence number (RSN): Xrsn,1, Xrsn,2
E-TFCI: Xtfci,1, Xtfci,2,
“Happy” bit: Xh,1

In order to differentiate from other E-DPCCHs used for data transmission, bits in the E-TFCI field, Xtfci,1, Xfci,2, Xtfci,7, may be set to a special value that is not conflicting with other regular values in use. With reference to 3GPP standard specifications for the MAC protocol, there exist some reserved E-TFCI values that may be utilized for this purpose. They are listed in Table 1 for each of the E-TFCI tables configured for 2 ms TTI E-DCH. Table 1 shows reserved E-TFCI values used for the EDPCCH order signaling. Note that these values are represented by a decimal number that needs to be converted to the 7 bit binary and mapped to Xtfci,1, Xtfci,2, Xtfci,7.

TABLE 1

| | E-TFCI used for the |
|---|---|
| E-TFCI Tables | order signaling |
| in use | (decimal) |
| Table 0 | 120 |
| Table 1 | 115 |
| Table 2 | 121 |
| Table 3 | 101 or 102 |

To facilitate the signaling needs, the rest of the bits in E-DPCCH, Xrsn,1, Xrsn,2 Xh,1, may be reinterpreted with different meanings from before. Label the

Indicator Type bits as Xidt,1, Xidt,2 and the Indicator bits as Xind,1. These new information
fields may be mapped to the original bits by:
   Xrsn,1=Xidt,1, Xrsn,2=Xidt,2, Xh,1=Xind,1

With the new definition of the E-DPCCH fields, the signaling for enabling/disabling the transmit diversity may be implemented, e.g., by the following bit assignment:

If Indicator type Xidt,1, Xidt,2=‘00’, then the mapping for Xind,1 is as follows:

Xind,1, is comprised of:
Transmission diversity enabling (1 bits): Xind,1=Xtxd,1
If Xtxd,1=‘0’, then the E-DPCCH order is an uplink transmit diversity disabling indicator.
If Xtxd,1=1’, then the E-DPCCH order is an uplink transmit diversity enabling indicator.

Though the example described above illustrates one way of E-DPCCH bit assignment for the purpose of signaling to network, it should be understood that following the same principle, many other possible forms of bit assignment may also apply. For example, one bit for Indicator Type,Xh,1=Xidt,1, and two bits for the Indicator Bits, Xrsn,1=Xind,1, Xrsn,2=Xind,2.

The WTRU may convey the information to the network via L2 signaling. For example, it may use the special value of LCH-ID in the MAC-i header or use one or two values of the 4 spare bits in the field to indicate the use of transmit diversity.

The WTRU may enable/disable the uplink transmit diversity without indicating it to the network.

Signaling may be implemented to indicate the occurrence of antenna switching. When the antenna switching occurs, the occurrence may be indicated by increasing the power of E-DPCCH and/or E-DPDCH at the first TTI, or first group of TTIs after the switching, from which the base station receiver may detect the power change and thus be informed about start of the probing mode. An additional benefit may be that the higher power may assist the channel estimation if a decision direct algorithm is utilized in the receiver over the E-DPCCH signal. The WTRU may decrease the power of the E-DPCCH and/or E-DPDCH to avoid unnecessary noise rise increases. The amount of power increase or decrease may be fixed, e.g., in specifications or signaled by the network.

The field of the happy bit may be reused in the E-DPCCH. The happy bit field in a specific TTI may be re-designated as the “switch bit.” This specific TTI may be agreed upon by both the WTRU and base station to be a specific HARQ process, or the first out of a set of consecutive N TTIs (e.g., every 15 TTIs corresponding to once every frame). For example, every HARQ process 0 out of the 8 HARQ processes may be identified as the TTI to indicate the occurrence of the antenna switching.

Signaling may be implemented to indicate the probing mode. The method of using the E-TFCI field of the E-DPCCH as described herein may be used to indicate the probing mode. More specifically, the same reserved E-TFCI as given in Table 1 may be applied, but the Indicator type field may be set differently, for example:

If Indicator type Xidt,1, Xidt,2=‘01’, then the mapping for Xind,1 may be as follows:

Xind,1, is comprised of
Transmission diversity enabling (1 bits): Xind,1=Xprob,1

If Xprob,1=‘0’, then the WTRU is in operation mode
If Xprob,1=‘1’, then the WTRU is in probing mode.

The same principle may be followed to provide other forms of bit assignment.

The probing mode may be signaled by increasing the power of E-DPCCH and/or E-DPDCH during the entire or part of probing phase. The base station receiver may detect the power change and thus be informed about start of the probing mode. The higher power may assist the channel estimation if a decision direct algorithm is utilized in the receiver over the E-DPCCH and/or E-DPDCH signal. The power of the E-DPCCH and/or E-DPDCH may be reduced during the probing phase. The amount of power increase or reduction may be pre-defined or signaled by the network.

Although features and elements are described above in particular combinations, each feature or element can be used alone without the other features and elements or in various combinations with or without other features and elements. The methods or flow charts provided herein may be implemented in a computer program, software, or firmware incorporated in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (WTRU), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) or Ultra Wide Band (UWB) module.

FIG. 27A is a diagram of an example communications system 2700 in which one or more disclosed embodiments may be implemented. The communications system 2700 may be a multiple access system that provides content, such as voice, data, video, messaging, broadcast, etc., to multiple wireless users. The communications system 2700 may enable multiple wireless users to access such content through the sharing of system resources, including wireless bandwidth. For example, the communications systems 2700 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 27A, the communications system 2700 may include wireless transmit/receive units (WTRUs) 2702a, 2702b, 2702c, 2702d, a radio access network (RAN) 2704, a core network 2706, a public switched telephone network (PSTN) 2708, the Internet 2710, and other networks 2712, though it will be appreciated that the disclosed embodiments contemplate any number of WTRUs, base stations, networks, and/or network elements. Each of the WTRUs 2702a, 2702b, 2702c, 2702d may be any type of device configured to operate and/or communicate in a wireless environment. By way of example, the WTRUs 2702a, 2702b, 2702c, 2702d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications systems 2700 may also include a base station 2714a and a base station 2714b. Each of the base stations 2714a, 2714b may be any type of device configured to wirelessly interface with at least one of the WTRUs 2702a, 2702b, 2702c, 2702d to facilitate access to one or more communication networks, such as the core network 2706, the Internet 2710, and/or the networks 2712. By way of example, the base stations 2714a, 2714b may be a base transceiver station (BTS), a Node-B, an eNode B, a Home Node B, a Home eNode B, a site controller, an access point (AP), a wireless router, and the like. While the base stations 2714a, 2714b are each depicted as a single element, it will be appreciated that the base stations 2714a, 2714b may include any number of interconnected base stations and/or network elements.

The base station 2714a may be part of the RAN 2704, which may also include other base stations and/or network elements (not shown), such as a base station controller (BSC), a radio network controller (RNC), relay nodes, etc. The base station 2714a and/or the base station 2714b may be configured to transmit and/or receive wireless signals within a particular geographic region, which may be referred to as a cell (not shown). The cell may further be divided into cell sectors. For example, the cell associated with the base station 2714a may be divided into three sectors. Thus, in one embodiment, the base station 2714a may include three transceivers, i.e., one for each sector of the cell. In another embodiment, the base station 2714a may employ multiple-input multiple output (MIMO) technology and, therefore, may utilize multiple transceivers for each sector of the cell.

The base stations 2714a, 2714b may communicate with one or more of the WTRUs 2702a, 2702b, 2702c, 2702d over an air interface 2716, which may be any suitable wireless communication link (e.g., radio frequency (RF), microwave, infrared (IR), ultraviolet (UV), visible light, etc.). The air interface 2716 may be established using any suitable radio access technology (RAT).

More specifically, as noted above, the communications system 2700 may be a multiple access system and may employ one or more channel access schemes, such as CDMA, TDMA, FDMA, OFDMA, SC-FDMA, and the like. For example, the base station 2714a in the RAN 2704 and the WTRUs 2702a, 2702b, 2702c may implement a radio technology such as Universal Mobile Telecommunications System (UMTS) Terrestrial Radio Access (UTRA), which may establish the air interface 2716 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 2714a and the WTRUs 2702a, 2702b, 2702c may implement a radio technology such as Evolved UMTS Terrestrial Radio Access (E-UTRA), which may establish the air interface 2716 using Long Term Evolution (LTE) and/or LTE-Advanced (LTE-A).

In other embodiments, the base station 2714a and the WTRUs 2702a, 2702b, 2702c may implement radio technologies such as IEEE 802.16 (i.e., Worldwide Interoperability for Microwave Access (WiMAX)), CDMA2000, CDMA2000 IX, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 2714b in FIG. 27A may be a wireless router, Home Node B, Home eNode B, or access point, for example, and may utilize any suitable RAT for facilitating wireless connectivity in a localized area, such as a place of business, a home, a vehicle, a campus, and the like. In one embodiment, the base station 2714b and the WTRUs 2702c, 2702d may implement a radio technology such as IEEE 802.11 to establish a wireless local area network (WLAN). In another embodiment, the base station 2714b and the WTRUs 2702c, 2702d may implement a radio technology such as IEEE 802.15 to establish a wireless personal area network (WPAN). In yet another embodiment, the base station 2714b and the WTRUs 2702c, 2702d may utilize a cellular-based RAT (e.g., WCDMA, CDMA2000, GSM, LTE, LTE-A, etc.) to establish a picocell or femtocell. As shown in FIG. 27A, the base station 2714b may have a direct connection to the Internet 2710. Thus, the base station 2714b may not be required to access the Internet 2710 via the core network 2706.

The RAN 2704 may be in communication with the core network 2706, which may be any type of network configured to provide voice, data, applications, and/or voice over internet protocol (VoIP) services to one or more of the WTRUs 2702a, 2702b, 2702c, 2702d. For example, the core network 2706 may provide call control, billing services, mobile location-based services, pre-paid calling, Internet connectivity, video distribution, etc., and/or perform high-level security functions, such as user authentication. Although not shown in FIG. 27A, it will be appreciated that the RAN 2704 and/or the core network 2706 may be in direct or indirect communication with other RANs that employ the same RAT as the RAN 2704 or a different RAT. For example, in addition to being connected to the RAN 2704, which may be utilizing an E-UTRA radio technology, the core network 2706 may also be in communication with another RAN (not shown) employing a GSM radio technology.

The core network 2706 may also serve as a gateway for the WTRUs 2702a, 2702b, 2702c, 2702d to access the PSTN 2708, the Internet 2710, and/or other networks 2712. The PSTN 2708 may include circuit-switched telephone networks that provide plain old telephone service (POTS). The Internet 2710 may include a global system of interconnected computer networks and devices that use common communication protocols, such as the transmission control protocol (TCP), user datagram protocol (UDP) and the internet protocol (IP) in the TCP/IP internet protocol suite. The networks 2712 may include wired or wireless communications networks owned and/or operated by other service providers. For example, the networks 2712 may include another core network connected to one or more RANs, which may employ the same RAT as the RAN 2704 or a different RAT.

Some or all of the WTRUs 2702a, 2702b, 2702c, 2702d in the communications system 2700 may include multi-mode capabilities, i.e., the WTRUs 2702a, 2702b, 2702c, 2702d may include multiple transceivers for communicating with different wireless networks over different wireless links. For example, the WTRU 2702c shown in FIG. 27A may be configured to communicate with the base station 2714a, which may employ a cellular-based radio technology, and with the base station 2714b, which may employ an IEEE 802 radio technology.

FIG. 27B is a system diagram of an example WTRU 2702. As shown in FIG. 27B, the WTRU 2702 may include a processor 2718, a transceiver 2720, a transmit/receive element 2722, a speaker/microphone 2724, a keypad 2726, a display/touchpad 2728, non-removable memory 2706, removable memory 2732, a power source 2734, a global positioning system (GPS) chipset 2736, and other peripherals 2738. It will be appreciated that the WTRU 2702 may include any sub-combination of the foregoing elements while remaining consistent with an embodiment.

The processor 2718 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 2718 may perform signal coding, data processing, power control, input/output processing, and/or any other functionality that enables the WTRU 2702 to operate in a wireless environment. The processor 2718 may be coupled to the transceiver 2720, which may be coupled to the transmit/receive element 2722. While FIG. 27B depicts the processor 2718 and the transceiver 2720 as separate components, it will be appreciated that the processor 2718 and the transceiver 2720 may be integrated together in an electronic package or chip.

The transmit/receive element 2722 may be configured to transmit signals to, or receive signals from, a base station (e.g., the base station 2714a) over the air interface 2716. For example, in one embodiment, the transmit/receive element 2722 may be an antenna configured to transmit and/or receive RF signals. In another embodiment, the transmit/receive element 2722 may be an emitter/detector configured to transmit and/or receive IR, UV, or visible light signals, for example. In yet another embodiment, the transmit/receive element 2722 may be configured to transmit and receive both RF and light signals. It will be appreciated that the transmit/receive element 2722 may be configured to transmit and/or receive any combination of wireless signals.

In addition, although the transmit/receive element 2722 is depicted in FIG. 27B as a single element, the WTRU 2702 may include any number of transmit/receive elements 2722. More specifically, the WTRU 2702 may employ MIMO technology. Thus, in one embodiment, the WTRU 2702 may include two or more transmit/receive elements 2722 (e.g., multiple antennas) for transmitting and receiving wireless signals over the air interface 2716.

The transceiver 2720 may be configured to modulate the signals that are to be transmitted by the transmit/receive element 2722 and to demodulate the signals that are received by the transmit/receive element 2722. As noted above, the WTRU 2702 may have multi-mode capabilities. Thus, the transceiver 2720 may include multiple transceivers for enabling the WTRU 2702 to communicate via multiple RATs, such as UTRA and IEEE 802.11, for example.

The processor 2718 of the WTRU 2702 may be coupled to, and may receive user input data from, the speaker/microphone 2724, the keypad 2726, and/or the display/touchpad 2728 (e.g., a liquid crystal display (LCD) display unit or organic light-emitting diode (OLED) display unit). The processor 2718 may also output user data to the speaker/microphone 2724, the keypad 2726, and/or the display/touchpad 2728. In addition, the processor 2718 may access information from, and store data in, any type of suitable memory, such as the non-removable memory 2706 and/or the removable memory 2732. The non-removable memory 2706 may include random-access memory (RAM), read-only memory (ROM), a hard disk, or any other type of memory storage device. The removable memory 2732 may include a subscriber identity module (SIM) card, a memory stick, a secure digital (SD) memory card, and the like. In other embodiments, the processor 2718 may access information from, and store data in, memory that is not physically located on the WTRU 2702, such as on a server or a home computer (not shown).

The processor 2718 may receive power from the power source 2734, and may be configured to distribute and/or control the power to the other components in the WTRU 2702. The power source 2734 may be any suitable device for powering the WTRU 2702. For example, the power source 2734 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 2718 may also be coupled to the GPS chipset 2736, which may be configured to provide location information (e.g., longitude and latitude) regarding the current location of the WTRU 2702. In addition to, or in lieu of, the information from the GPS chipset 2736, the WTRU 2702 may receive location information over the air interface 2716 from a base station (e.g., base stations 2714a, 2714b) and/or determine its location based on the timing of the signals being received from two or more nearby base stations. It will be appreciated that the WTRU 2702 may acquire location information by way of any suitable location-determination method while remaining consistent with an embodiment.

The processor 2718 may further be coupled to other peripherals 2738, which may include one or more software and/or hardware modules that provide additional features, functionality and/or wired or wireless connectivity. For example, the peripherals 2738 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 27C is a system diagram of the RAN 2704 and the core network 2706 according to an embodiment. As noted above, the RAN 2704 may employ a UTRA radio technology to communicate with the WTRUs 2702a, 2702b, 2702c over the air interface 2716. The RAN 2704 may also be in communication with the core network 2706. As shown in FIG. 27C, the RAN 2704 may include Node-Bs 2740a, 2740b, 2740c, which may each include one or more transceivers for communicating with the WTRUs 2702a, 2702b, 2702c over the air interface 2716. The Node-Bs 2740a, 2740b, 2740c may each be associated with a particular cell (not shown) within the RAN 2704. The RAN 2704 may also include RNCs 2742a, 2742b. It will be appreciated that the RAN 2704 may include any number of Node-Bs and RNCs while remaining consistent with an embodiment.

As shown in FIG. 27C, the Node-Bs 2740a, 2740b may be in communication with the RNC 2742a. Additionally, the Node-B 2740c may be in communication with the RNC 2742b. The Node-Bs 2740a, 2740b, 2740c may communicate with the respective RNCs 2742a, 2742b via an Iub interface. The RNCs 2742a, 2742b may be in communication with one another via an lur interface. Each of the RNCs 2742a, 2742b may be configured to control the respective Node-Bs 2740a, 2740b, 2740c to which it is connected. In addition, each of the RNCs 2742a, 2742b may be configured to carry out or support other functionality, such as outer loop power control, load control, admission control, packet scheduling, handover control, macrodiversity, security functions, data encryption, and the like.

The core network 2706 shown in FIG. 27C may include a media gateway (MGW) 2744, a mobile switching center (MSC) 2746, a serving GPRS support node (SGSN) 2748, and/or a gateway GPRS support node (GGSN) 2750. While each of the foregoing elements are depicted as part of the core network 2706, it will be appreciated that any one of these elements may be owned and/or operated by an entity other than the core network operator.

The RNC 2742a in the RAN 2704 may be connected to the MSC 2746 in the core network 2706 via an IuCS interface. The MSC 2746 may be connected to the MGW 2744. The MSC 2746 and the MGW 2744 may provide the WTRUs 2702a, 2702b, 2702c with access to circuit-switched networks, such as the PSTN 2708, to facilitate communications between the WTRUs 2702a, 2702b, 2702c and traditional land-line communications devices.

The RNC 2742a in the RAN 2704 may also be connected to the SGSN 2748 in the core network 2706 via an IuPS interface. The SGSN 2748 may be connected to the GGSN 2750. The SGSN 2748 and the GGSN 2750 may provide the WTRUs 2702a, 2702b, 2702c with access to packet-switched networks, such as the Internet 2710, to facilitate communications between and the WTRUs 2702a, 2702b, 2702c and IP-enabled devices.

As noted above, the core network 2706 may also be connected to the networks 2712, which may include other wired or wireless networks that are owned and/or operated by other service providers.

What is claimed:

1. A method for determining a channel condition for each of a plurality of antennas in a wireless transmit/receiver unit (WTRU) that utilizes multiple antennas, the method comprising:
holding transmit power constant during a period of a probing phase;
transmitting a probing signal from each of a first antenna and a second antenna during the period, wherein the first antenna transmits during a first time interval and the second antenna transmits during a second time interval;
receiving channel quality information related to the transmitted probing signals; and
switching an antenna based on the received channel quality information.

2. The method of claim 1, wherein the received channel quality information includes an indicator that identifies one of the first antenna or second antenna to use for transmitting data.

3. The method of claim 1, further comprising evaluating the received channel quality information, wherein the received channel quality information includes one or more measurements relating to the transmitted probing signals.

4. The method of claim 3, wherein the one or more measurements include: a channel estimation result, an SIR, a BLER, an estimated receive power, or a UE speed.

5. The method of claim 1, wherein the holding is performed during a switch cycle.

6. A method for determining a channel condition for each of a plurality of antennas relating to a wireless transmit/receiver unit (WTRU) utilizing multiple antennas, the method comprising:
receiving a probing signal from each of a first antenna and a second antenna, wherein each probing signal is transmitted in a period of a probing phase during which the transmit power is held constant, and wherein the first antenna transmits during a first time interval and the second antenna transmits during a second time interval;
determining channel quality information related to the received probing signals, wherein the channel quality information comprises information relating to antenna switching; and
sending the channel quality information.

7. The method of claim 6, wherein the channel quality information includes an indicator that identifies one of the first antenna or second antenna is to be used for transmitting data.

8. The method of claim 6, wherein the channel quality information includes one or more measurements relating to the received probing signals.

9. The method of claim 8, wherein the one or more measurements include: a channel estimation result, an SIR, a BLER, an estimated receive power, or a UE speed.

10. A method for determining a channel condition for each of a plurality of antennas relating to a wireless transmit/receiver unit (WTRU) utilizing multiple antennas, the method comprising:
receiving a first probing signal from a first antenna at a first measurement time and a second probing signal from a second antenna at a second measurement time, wherein the probing signals are transmitted in a period of a probing phase;
determining a power change offset from the first measurement time to the second measurement time;
calculating channel quality information related to the received probing signals, wherein the calculating comprises using the power change offset to compensate for a transmission power difference between the received probing signals, and wherein the channel quality information comprises information relating to antenna switching; and
sending the channel quality information.

11. The method of claim 10, wherein determining the power change offset includes tracking a transmit power control command.

12. The method of claim 10, wherein the channel quality information includes an indicator that identifies one of the first antenna or second antenna is to be used for transmitting data.

13. The method of claim 10, wherein the channel quality information includes one or more measurements relating to the received probing signals.

14. The method of claim 13, wherein the one or more measurements include: a channel estimation result, an SIR, a BLER, an estimated receive power, or a UE speed.

15. A method for determining a channel condition for each of a plurality of antennas in a wireless transmit/receiver unit (WTRU) that utilizes multiple antennas, the method comprising:
transmitting a probing signal from each of a first antenna and a second antenna during a period of a probing phase;
receiving channel quality information relating to the transmitted probing signals, wherein the channel quality information compensates for a transmission power difference between the transmitted probing signals, and wherein the channel quality information comprises information relating to antenna switching; and
switching an antenna based on the channel quality information.

16. The method of claim 15, wherein the received channel quality information includes an indicator that identifies one of the first antenna or second antenna to use for transmitting data.

17. The method of claim 15, further comprising evaluating the received channel quality information, wherein the received channel quality information includes one or more measurements relating to the transmitted probing signals.

18. The method of claim 17, wherein the one or more measurements include: a channel estimation result, an SIR, a BLER, an estimated receive power, or a UE speed.
